(19) United States
(12) Patent Application Publication
(10) Pub. No.: US 2023/0224012 A1
(43) Pub. Date: Jul. 13, 2023

(54) FEEDBACK CODEBOOK GENERATION BASED ON TRANSMISSION SCHEDULING RULES

(71) Applicant: QUALCOMM Incorporated, San Diego, CA (US)

(72) Inventors: Ahmed Abdelaziz Ibrahim Abdelaziz Zewail, San Diego, CA (US); Jing Sun, San Diego, CA (US); Mostafa Khoshnevisan, San Diego, CA (US); Qingjiang Tian, San Diego, CA (US)

(21) Appl. No.: 17/571,266

(22) Filed: Jan. 7, 2022

(51) Int. Cl. H04B 7/06; H04W 72/04; H04W 72/14

(52) U.S. Cl. CPC H04B 7/0639; H04W 72/0413; H04W 72/14; H04W 72/1289

(57) ABSTRACT

Methods, systems, and devices for wireless communications are described. The method may include a user equipment (UE) receiving a first grant allocating a first set of downlink resources to the UE and a second grant allocating a second set of downlink resources to the UE, where the second grant is received after the first grant. The UE may determine that a slot comprises both resources of the first set and resources of the second set and generate a feedback codebook for downlink signaling scheduled to be received over one or both of the first set of downlink resources or the second set of downlink resources, where a size of the feedback codebook is based on the slot comprising both resources of the first set and resources of the second set. The UE may then transmit the feedback codebook to the base station.

### FIELD OF TECHNOLOGY

The following relates to wireless communications, including feedback codebook generation based on transmission scheduling rules.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a UE may transmit feedback information to a base station. The feedback information may indicate whether or not the UE successfully received downlink signaling from the base station. In some examples, the UE may transmit the feedback information in a hybrid automatic repeat request (HARQ) codebook. The HARQ codebook may include a number of feedback bits. An acknowledgement (ACK) bit may indicate that downlink signaling scheduled to be received over resources of slot was received successfully by the UE, whereas a negative acknowledgement (NACK) bit may indicate that downlink signaling scheduled to be received over resource of a slot was not received successfully by the UE.

### SUMMARY

The described techniques relate to improved methods, systems, devices, and apparatuses that support feedback codebook generation based on transmission scheduling rules. Generally, the described techniques provide for a user equipment (UE) to generate a hybrid automatic repeat request (HARQ) codebook based on out of order (OOO) scheduling rules. In some examples, a base station may transmit one or more grants to the UE. For example, the base station may transmit a first grant allocating a first set of downlink resource to the UE and a second grant allocating a second set of downlink resources to the UE, where the first grant is received prior to the second grant. The UE may determine that a slot includes resources of the first set and resources of the second set and generate a HARQ codebook including feedback information for downlink signaling scheduled to be received over one or both of the first set of resources or the second set of resources, where the size of the HARQ codebook may be based on the determination that the slot includes the resources of the first set and the resources of the second set. The UE may transmit the HARQ codebook to the base station.

A method for wireless communication at a UE is described. The method may include receiving, from a base station, a first grant allocating a first set of downlink resources to the UE, receiving, from the base station and after receiving the first grant, a second grant allocating a second set of downlink resources to the UE, determining that a slot includes both resources of the first set of downlink resources and resources of the second set of downlink resources, generating a feedback codebook for downlink signaling scheduled to be received over the first set of downlink resources, the second set of downlink resources, or both, where a size of the feedback codebook is based on the slot including both resources of the first set of downlink resources and resources of the second set of downlink resources, and transmitting, to the base station, the feedback codebook based on generating the feedback codebook.

An apparatus for wireless communication is described. The apparatus may include a memory, a transceiver, and at least one processor of a UE, the at least one processor coupled with the memory and the transceiver. The at least one processor may be configured to cause the apparatus to receive, from a base station, a first grant allocating a first set of downlink resources to the UE, receive, from the base station and after receiving the first grant, a second grant allocating a second set of downlink resources to the UE, determine that a slot includes both resources of the first set of downlink resources and resources of the second set of downlink resources, generate a feedback codebook for downlink signaling scheduled to be received over the first set of downlink resources, the second set of downlink resources, or both, where a size of the feedback codebook is based on the slot including both resources of the first set of downlink resources and resources of the second set of downlink resources, and transmit, to the base station, the feedback codebook based on generating the feedback codebook.

Another apparatus for wireless communication at a UE is described. The apparatus may include means for receiving, from a base station, a first grant allocating a first set of downlink resources to the UE, means for receiving, from the base station and after receiving the first grant, a second grant allocating a second set of downlink resources to the UE, means for determining that a slot includes both resources of the first set of downlink resources and resources of the second set of downlink resources, means for generating a feedback codebook for downlink signaling scheduled to be received over the first set of downlink resources, the second set of downlink resources, or both, where a size of the feedback codebook is based on the slot including both resources of the first set of downlink resources and resources of the second set of downlink resources, and means for transmitting, to the base station, the feedback codebook based on generating the feedback codebook.

A non-transitory computer-readable medium storing code for wireless communication at a UE is described. The code may include instructions executable by a processor to receive, from a base station, a first grant allocating a first set of downlink resources to the UE, receive, from the base station and after receiving the first grant, a second grant allocating a second set of downlink resources to the UE, determine that a slot includes both resources of the first set of downlink resources and resources of the second set of downlink resources, generate a feedback codebook for downlink signaling scheduled to be received over the first set of downlink resources, the second set of downlink resources, or both, where a size of the feedback codebook is based on the slot including both resources of the first set of downlink resources and resources of the second set of downlink resources, and transmit, to the base station, the feedback codebook based on generating the feedback codebook.

Some examples of the method, apparatuses, and non-transitory computer-readable medium described herein may further include operations, features, means, or instructions for determining, based on determining that the slot includes both the resources of the first set of downlink resources and the resources of the second set of downlink resources, whether the resources of the first set of downlink resources may be earlier in the slot than the resources of the second set of downlink resources, where the size of the feedback codebook may be further based on whether the resources of the first set of downlink resources may be earlier in the slot than the resources of the second set of downlink resources.

In some examples of the method, apparatuses, and non-transitory computer-readable medium described herein, generating the feedback codebook may include operations, features, means, or instructions for generating a single feedback bit for the slot based on determining that the resources of the first set of downlink resources may be not earlier in the slot than the resources of the second set of downlink resources.

In some examples of the method, apparatuses, and non-transitory computer-readable medium described herein, generating the feedback codebook may include operations, features, means, or instructions for generating at least two feedback bits for the slot based on determining that the resources of the first set of downlink resources may be earlier in the slot than the resources of the second set of downlink resources.

In some examples of the method, apparatuses, and non-transitory computer-readable medium described herein, the first set of downlink resources spans a set of multiple slots and a last slot of set of multiple slots includes the slot.

In some examples of the method, apparatuses, and non-transitory computer-readable medium described herein, the first set of downlink resources may be entirely within the slot and the second set of downlink resources spans a set of multiple slots, a first slot of the set of multiple slots including the slot.

Some examples of the method, apparatuses, and non-transitory computer-readable medium described herein may further include operations, features, means, or instructions for determining that the first set of downlink resources and the second set of downlink resources may be both entirely within the slot, where generating the feedback codebook includes generating at least two feedback bits for the slot based on determining that the first set of downlink resources and the second set of downlink resources may be both entirely within the slot.

Some examples of the method, apparatuses, and non-transitory computer-readable medium described herein may further include operations, features, means, or instructions for determining the size of the feedback codebook based on the slot including both resources of the first set of downlink resources and resources of the second set of downlink resources.

In some examples of the method, apparatuses, and non-transitory computer-readable medium described herein, determining the size of the feedback codebook may include operations, features, means, or instructions for determining a first quantity of feedback bits to include in the feedback codebook for scheduled downlink signaling on the first set of downlink resources, determining a second quantity of feedback bits to include in the feedback codebook for scheduled downlink signaling on the second set of downlink resources, and determining a maximum quantity of feedback bits for the feedback codebook based on the first quantity of feedback bits and the second quantity of feedback bits, the size of the feedback codebook equal to the maximum quantity of feedback bits.

In some examples of the method, apparatuses, and non-transitory computer-readable medium described herein, determining the maximum quantity of feedback bits may include operations, features, means, or instructions for determining that the first set of downlink resources and the second set of downlink resources do not overlap one another in a time domain and determining a third quantity of feedback bits, where the third quantity of feedback bits corresponds to a combination of the first quantity of feedback bits and the second quantity of feedback bits, and where the third quantity of feedback bits may be equal to the maximum quantity of feedback bits.

Some examples of the method, apparatuses, and non-transitory computer-readable medium described herein may further include operations, features, means, or instructions for receiving, from the base station, a third grant allocating a third set of downlink resources to the UE, determining a fourth quantity of feedback bits to include in the feedback codebook for scheduled downlink signaling on the third set of downlink resources, determining that the third set of downlink resources and the first set of downlink resources do not overlap one another in a time domain, and determining a fifth quantity of feedback bits, where the fifth quantity of feedback bits corresponds to a combination of the first quantity of feedback bits and the fourth quantity of feedback bits, and where the maximum quantity of feedback bits may be equal to the third quantity of feedback bits based on the fifth quantity of feedback bits being less than the third quantity of feedback bits.

In some examples of the method, apparatuses, and non-transitory computer-readable medium described herein, the first grant and the second grant each include multi-physical downlink shared channel (PDSCH) scheduling downlink control information (DCI) or single-PDSCH scheduling DCI.

In some examples of the method, apparatuses, and non-transitory computer-readable medium described herein, the feedback codebook includes a type-1 HARQ codebook.

### BRIEF DESCRIPTION OF THE DRAWINGS

FIGS. 1 and 2 illustrate examples of a wireless communications system that supports feedback codebook generation based on transmission scheduling rules in accordance with aspects of the present disclosure.

FIG. 3A illustrates an example of a flow diagram that supports feedback codebook generation based on transmission scheduling rules in accordance with aspects of the present disclosure.

FIGS. 3B, 3C, and 3D illustrate examples of a frame format the supports feedback codebook generation based on transmission scheduling rules in accordance with aspects of the present disclosure.

FIG. 4A illustrates an example of a flow diagram that supports feedback codebook generation based on transmission scheduling rules in accordance with aspects of the present disclosure.

FIG. 4B illustrates an example of a flow diagram that supports feedback codebook generation based on transmission scheduling rules in accordance with aspects of the present disclosure.

FIG. 5 illustrates an example of a process flow that supports feedback codebook generation based on transmission scheduling rules in accordance with aspects of the present disclosure.

FIGS. 6 and 7 show block diagrams of devices that support feedback codebook generation based on transmission scheduling rules in accordance with aspects of the present disclosure.

FIG. 8 shows a block diagram of a communications manager that supports feedback codebook generation based on transmission scheduling rules in accordance with aspects of the present disclosure.

FIG. 9 shows a diagram of a system including a device that supports feedback codebook generation based on transmission scheduling rules in accordance with aspects of the present disclosure.

FIGS. 10 through 12 show flowcharts illustrating methods that support feedback codebook generation based on transmission scheduling rules in accordance with aspects of the present disclosure.

### DETAILED DESCRIPTION

In some examples, a user equipment (UE) may transmit feedback information to a base station indicating whether or not the UE received downlink signaling from the base station. The feedback information may be included in a hybrid automatic repeat request (HARQ) codebook. The HARQ codebook may include a quantity of feedback bits, where each bit corresponds to respective downlink signaling. If the UE successfully receives a downlink signal, the corresponding bit may be an acknowledgement (ACK) bit. Alternatively, if the UE does not successfully receive the downlink signal, the corresponding bit may be a negative acknowledgement (NACK) bit. In some examples, the UE may abide by out of order (OOO) scheduling rules that specify that the UE may not expect to receive downlink signaling that starts earlier than different downlink signaling that is scheduled by a previously received downlink grant. Taking into account the OOO scheduling rules, the UE may generate a single ACK/NACK bit for a slot that includes non-overlapping resources of two different grants as opposed to generating two or more ACK/NACK bits when not considering OOO scheduling rules. But the UE may not account for this reduction in ACK/NACK bits when generating the HARQ codebook resulting in a HARQ codebook size that may larger than what is necessary. The larger HARQ codebook size may consume more resources and decrease a coding rate at the UE.

In some examples, a UE may take into account OOO scheduling rules when generating a HARQ codebook. In some examples, the UE may receive a first resource grant indicating a first set of downlink resources. Additionally, after receiving the first resource grant, the UE may receive a second resource grant indicating a second set of downlink resources. In one example, the UE may generate HARQ codebook for downlink signaled scheduled by the first resource grant and the second resource grant based on a set of rules that considers OOO scheduling. First, the UE may identify a slot that includes both resources of the first set and resources of the second set. The UE may then generate one or more ACK/NACK bits for the slot based on the set of rules. As one example, the set of rules may specify that if the first set of resources and the second set of resources are within the slot, the UE may generate two ACK/NACK bits for the slot. One ACK/NACK bit for downlink signaling scheduled to be received on the first set of downlink resources and one ACK/NACK bit for downlink signaling scheduled to be received on the second set of downlink resources. Otherwise, the UE may generate a single ACK/NACK bit for the slot. The UE may also consider other rules when generating the one or more ACK/NACK bits for the slot.

Alternatively, the UE may generate a HARQ codebook for downlink signaling scheduled to be received over the first of downlink resources and the second set of downlink resources using a procedure that considers OOO scheduling. The UE may determine a span corresponding to the first set of downlink resources and a span corresponding to the second set of downlink resources and determine a total number of ACK/NACK bits to include in a HARQ codebook for each span. If the spans do not overlap (e.g., if the first set of downlink resources do not overlap the second set of downlink resources), the UE may set a size of the HARQ codebook equal to a combination of the number of ACK/NACK bits of the first span and the number of ACK/NACK bits of the second span. Using the methods as described herein may allow a UE to reduce the size of the HARQ codebook which may provide for an increased coding rate and more efficient use of communication resources.

Aspects of the disclosure are initially described in the context of wireless communications systems. Additional aspects of the disclosure are described in the context of flow diagrams, frame formats, and a process flow. Aspects of the disclosure are further illustrated by and described with reference to apparatus diagrams, system diagrams, and flowcharts that relate to feedback codebook generation based on transmission scheduling rules.

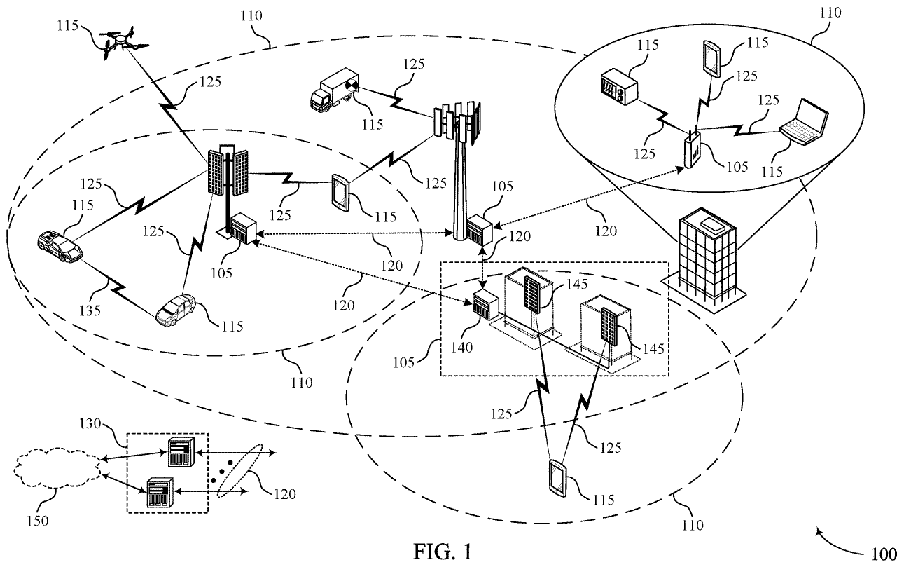

FIG. 1 illustrates an example of a wireless communications system 100 that supports feedback codebook generation based on transmission scheduling rules in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of T_{b}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

As described herein, the UE 115 may generate a HARQ codebook based on 000 scheduling rules. In some examples, a base station 105 may transmit one or more grants to the UE 115. For example, the base station 105 may transmit a first grant allocating a first set of downlink resource to the UE 115 and a second grant allocating a second set of downlink resources to the UE 115, where the first grant is received prior to the second grant. The UE 115 may determine that a slot includes resources of the first set and resources of the second set and generate a HARQ codebook including feedback information for downlink signaling scheduled to be received over one or both of the first set of resources or the second set of resources, where the size of the HARQ codebook may be based on the determination that the slot includes the resources of the first set and the resources of the second set. The UE 115 may transmit the HARQ codebook to the base station 105.

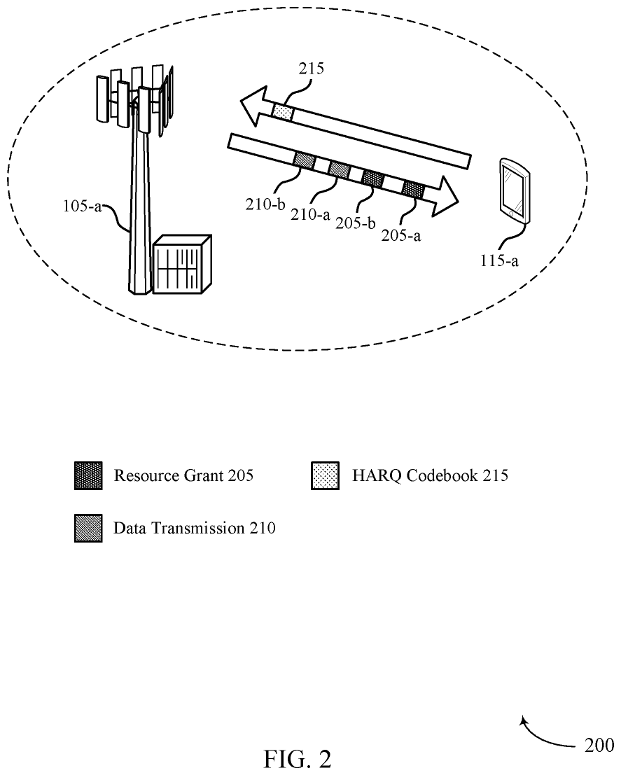

FIG. 2 illustrates an example of a wireless communications system 200 that supports feedback codebook generation based on transmission scheduling rules in accordance with aspects of the present disclosure. The wireless communications system 200 may include a base station 105-a and a UE 115-a. In some examples, the wireless communications system 200 may implement aspects of a wireless communications system 100. For example, the base station 105-a may be an example of a base station 105 as described with reference to FIG. 1. Additionally, the UE 115-a may be an example of a UE 115 as described with reference to FIG. 1.

In some examples, the UE 115-a may provide feedback to the base station 105-a regarding data transmissions 210 received from the base station 105-a. In one example, the base station 105-a may transmit a resource grant 205-a to the UE 115-a. The resource grant 205-a may allocate a first set of resources to the UE 115-a. The UE 115-a may utilize the first set of resources to receive a data transmission 210-a. To indicate whether the UE 115-a received the data transmission 210-a successfully (e.g., decoded the data transmission 210-a without error), the UE 115-a may transmit feedback information to the base station 105-a. If the UE 115-a receives the data transmission 210-a over the first set of resources successfully, the UE 115-a may transmit ACK feedback to the base station 105-a. Alternatively, if the UE 115-a does not receive the data transmission 210-a over the first set of resources successfully, the UE 115-a may transmit NACK feedback to the base station 105-a.

In some examples, the resource grant 205-a may be an example of a multi-physical downlink shared channel (PDSCH) resource grant or a single-PDSCH resource grant. If the resource grant 205-a is a multi-PDSCH resource grant, the data transmission 210-a may be made up of multiple transport blocks, where each transport block is transmitted in a separate slot. If the resource grant 205-a is a single-PDSCH resource grant, the data transmission 210-a may be made up of a single transport block that is transmitted in a single slot. In some examples, the UE 115-a may transmit the feedback information to the base station 105-a in a HARQ codebook 215. The HARQ codebook 215 may include a quantity of ACK/NACK bits. For each transport block of the data transmission 210-a, the UE 115-a may generate an ACK bit or a NACK bit and include the bits in the HARQ codebook 215. An ACK bit may indicate that a corresponding transport block was received successfully, whereas a NACK bit may indicate that a corresponding transport block was received unsuccessfully.

The HARQ codebook 215 may be transmitted over resources that make up the physical uplink control channel (PUCCH). The location of the PUCCH in relation to the first set of resources may be determined by an offset value (e.g., K1). The offset value may indicate a quantity of slots between a last slot over which the data transmission 210-a is received and the slot including the resources that make up the PUCCH. The offset value may be indicated via the resource grant 205-a. Each resource grant 205 received by the UE 115-a may indicate a corresponding offset value.

In some examples, the HARQ codebook 215 may include feedback information for multiple data transmissions 210 scheduled by different resource grants 205. As one example, the UE 115-a may receive a resource grant 205-b prior to, after, or during a same time period as the resource grant 205-a. The resource grant 205-b may allocate a second set of resources to the UE 115-a. The UE 115-a may utilize the second set of resources to receive a data transmission 210-b. The UE 115-a may generate ACK/NACK bits for the data transmission 210-b and include the ACK/NACK bits for the data transmission 210-b in the HARQ codebook 215 along with the ACK/NACK bits for the data transmission 210-a. As such, the size of the HARQ codebook 215 (e.g., a number of bits included in the HARQ codebook) may be equal to a quantity of ACK/NACK bits generated for the data transmission 210-a (e.g., transport blocks included in the data transmission 210-a) plus a quantity of ACK/NACK bits generated for the data transmission 210-b (e.g., quantity of transport blocks included in the data transmission 210-b).

In some examples, the UE 115-a may follow or operate in accordance with OOO scheduling rules. The OOO scheduling rules may indicate that the UE 115-a may not expect to receive a data transmission 210 if a resource grant 205 scheduling the data transmission is received after a resource grant 205 scheduling an earlier data transmission 210. As an example, if the resource grant 205-a ends in symbol i and the data transmission 210-a starts in symbol j, the UE 115-a may not expect to receive the data transmission 210-b if the data transmission 210-b starts before the last symbol of the data transmission 210-a and if the resource grant 205-b ends in a symbol later than the symbol i. In addition, resource grants 205 that end in the same symbol may be considered OOO scheduling if the resource grants 205 allocate overlapping resources to the UE 115. These OOO scheduling rules may apply to multi-PDSCH resource grants or single-PDSCH resource grants. Moreover, the same out of scheduling rules may be applied to resource grants scheduling uplink data transmissions.

Although the UE 115-a may not expect to receive a data transmission 210 based on the OOO scheduling rules, the UE 115-a may still report feedback information for the data transmission 210 or account for the feedback information in the HARQ codebook 215. For example, the UE 115-a may determine, based on the OOO scheduling rules, not to expect the data transmission 210-b. In one example, the UE 115-a may not receive the data transmission 210-b, but may still report feedback for the data transmission 210-b. That is, the HARQ codebook 215 may include ACK/NACK bits for the data transmission 210-b and the data transmission 210-a. However, because the UE 115-a does not actually receive the data transmission 210-b, the ACK/NACK bits included in the HARQ codebook 215 for the data transmission 210-b may be useless to the base station 105-b and including these ACK/NACK bits in the HARQ codebook 215 may consume excess resources. Alternatively, the UE 115-a may not include the ACK/NACK bits for the data transmission 210-b in the HARQ codebook 215, but the HARQ codebook size may account for the ACK/NACK bits for the data transmission 210-b. As such, the UE 115-a may allocate or reserve resources for transmission of a HARQ codebook whose size is larger than what is needed which may result in an inefficient use of resources.

As described herein, the UE 115-a may consider the OOO scheduling rules when generating the HARQ codebook 215. In one example, the UE 115-a may determine whether one or more slots include resources of multiple grants. As one example, the UE 115-a may determine whether a slot includes resources of the first set of resources allocated by the resource grant 205-a and resources of the second set of resources allocated by the resource grant 205-b. Once the UE 115-a locates the slot, the UE 115-a may determine whether the resources in the slot overlap one another. If the resources in the slot overlap one another, the UE 115-a may generate a single ACK/NACK bits for the slot (e.g., an ACK/NACK bit for a transport block of a data transmission that corresponds to the earliest resource grant of the multiple grants). Alternatively, if the resources of the slot do not overlap one another, the UE 115-a may generate one or more ACK/NACK bits for the slot based on a set of rules. The set of rules may specify to generate one ACK/NACK bit for the slot unless the resources corresponding to the multiple grants are fully within the slot, if the earlier resources in the slot are the last transport block for the corresponding data transmission 210, or if the later resources in the slot are the first transport block for the corresponding data transmission 210 and the earlier resources include the full corresponding data transmission 210.

As one example, the resources of the first set of resources may be located before the resources of the second set of resource in the slot and the resources of the first set of resources may not overlap the resources of the second set of resources. In such example, the UE 115-a may generate one ACK/NACK bit for the slot unless the slot fully includes the first set of resources and the second set of resources (e.g., the data transmission 210-a and the data transmission 210-b include one transport block which is located in the slot). Moreover, the UE 115-a may generate one ACK/NACK bit for the slot unless the resources of the first set of resources are for a last transport block of multiple transport blocks included in the data transmission 210-a. Additionally, the UE 115-a may generate one ACK/NACK bit unless the resources of the second set of resources are for the first transmit block of the multiple transport blocks included in the data transmission 210-b and the resources of the first set of resources are fully included in the slot. If the set of rules are not met, the UE 115-a may generate one ACK/NACK bit for the slot (e.g., one ACK/NACK bit for the data transmission 210-a in the slot). If the rules are met, the UE 115-a may generate multiple ACK/NACK bits for the slot (e.g., one ACK/NACK bit for the data transmission 210-a and one ACK/NACK bit for the data transmission 210-b). In addition, if the rules are met, the UE 115 may generate an ACK/NACK bit for each of the slots including resources of the first set of resources and resources of the second set of resources. Alternatively, if the rules are not met, the UE may generate an ACK/NACK bit for each slot including resources of the first set of resource, but may not generate an ACK/NACK bits for the data transmission 210-b for each slot including resources of the second set of resources.

In another example, the UE 115-a may generate the HARQ codebook using a procedure considering the OOO scheduling rules. The UE 115-a may determine a total span of each data transmission 210 scheduled by each resource grant 205. The span may be from a first symbol of the data transmission 210 to a last symbol of the data transmission 210. The UE may then determine a total number of ACK/NACK bits that may be included in the HARQ codebook for each data transmission 210. For example, the UE 115-a may determine that the data transmission 210-a spans five symbols which corresponds to five ACK/NACK bits. Additionally, the UE 115-a may determine that the data transmission 210-b spans three symbols which corresponds to three ACK/NACK bits. The UE 115-a may then determine whether any of the spans are non-overlapping with respect to one another. That is, the UE 115-a may determine if time resources over which a data transmission 210 is received does not overlap time resources over which a different data transmission 210 is received. In some examples, there may be more than one combination of non-overlapping spans.

Once the UE 115-a determines a set of possible non-overlapping spans, the UE 115-a may determine which combination of non-overlapping spans results in a largest quantity of ACK/NACK bits. To determine which of the combination of non-overlapping spans results in the largest quantity of ACK/NACK bits, the UE 115-a may sum the ACK/NACK bits of each span in a combination and compare the results to the other combinations in the set. As one example, the UE 115-a may determine that the span of data transmission 210-a does not overlap the span of data transmission 210-b and that the sum of the two spans is eight ACK/NACK bits. The UE 115-a may set the largest quantity of ACK/NACK bits equal to the HARQ codebook size. The UE 115-a may then generate the ACK/NACK bits and transmit the HARQ codebook 215 to the base station 105-a. Using the methods as described herein may allow the UE 115-a to reduce the HARQ codebook size when OOO scheduling rules are met. This decrease in HARQ codebook size may allow the UE 115-a to consume less resources.

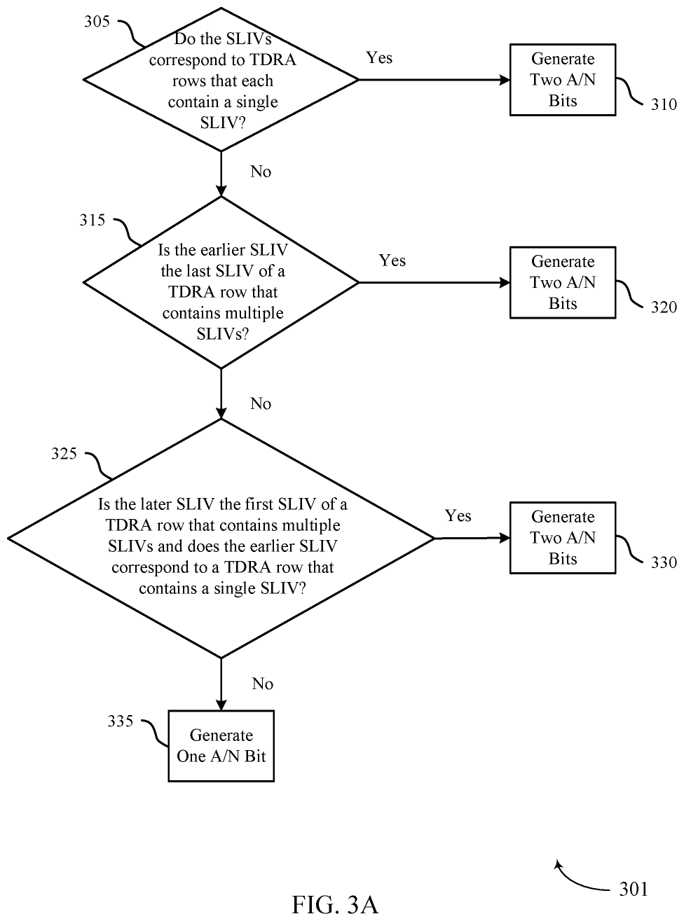

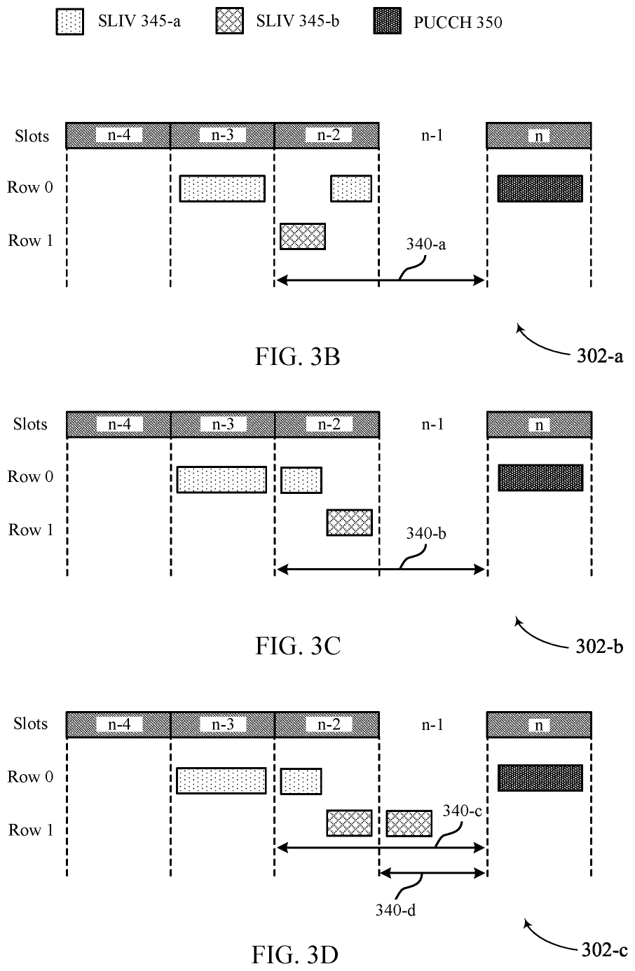

FIG. 3A illustrates an example of a flow diagram 301 that supports feedback codebook generation based on transmission scheduling rules in accordance with aspects of the present disclosure. In some examples, the flow diagram 301 may be implemented by aspects of a wireless communications system 100 and a wireless communications system 200. For example, the flow diagram 301 may be implemented by a UE 115 as described with reference to FIGS. 1 and 2.

FIGS. 3B, 3C, and 3D illustrate examples of a frame format 302 (e.g., a frame format 302-a, a frame format 302-b, and a frame format 302-c) that supports feedback codebook generation based on transmission scheduling rules in accordance with aspects of the present disclosure. In some examples, the frame format 302-a, the frame format 302-b, and the frame format 302-c may be implemented by aspects of a wireless communications system 100 and a wireless communications system 200. For example, the frame format 302-a, the frame format 302-b, and the frame format 302-c may be implemented by a UE 115 and a base station 105 as described with reference to FIGS. 1 and 2.

As described in FIG. 2, a UE may receive multiple resource grants from a base station, where each resource grant allocates resources for a PDSCH transmission. In some examples, to indicate the resources allocated for the PDSCH transmission, the grant may include a start and length indicator value (SLIV) 345. The SLIV may define the start symbol and a number of consecutive symbols for PDSCH allocation in a slot using a single number. In some examples, a resource grant may be an example of a multi-PDSCH resource grant or a single-PDSCH resource grant. A multi-PDSCH grant may indicate a SLIV for each slot, whereas a single PDSCH grant may indicate a single SLIV for a single slot.

Additionally, the resource grant may indicate an offset value 340 (e.g., K1). The offset value 340 may indicate a quantity of symbols between a last symbol used to transmit PDSCH of a corresponding resource grant and a PUCCH 350. The UE may utilize resources of the PUCCH to transmit a feedback codebook (e.g., a HARQ codebook) that includes feedback information (e.g., ACK/NACK bits) related to the received PDSCH transmissions.

The frame formats 302 illustrate examples of different PDSCH time domain resource allocations (TDRAs) that a UE may encounter when receiving multiple resource grants. For the frame format 302-a, the frame format 302-b, and the frame format 302-c, the UE may receive a first resource grant and a second resource grant. The first resource grant may correspond to TDRA row 0 and the second resource grant may correspond to TDRA row 1. In the frame format 302-a, the frame format 302-b, and the frame format 302-c, the first resource grant may be an example of a multi-PDSCH resource grant that indicates multiple SLIVs 345-a. In the frame format 302-a and the frame format 302-b, the second resource grant may be an example of a single-PDSCH resource grant that indicates a single SLIV 345-b. In frame format 302-c, the second resource grant may be an example of a multi-PDSCH grant that indicates multiple SLIVs 345-b.

Moreover, the first resource grant and the second resource grant may indicate an offset value 340. In the frame format 302-a, the first resource grant and the second resource grant may indicate an offset value 340-a which may equal to two. In the frame format 302-b, the first resource grant and the second resource grant may indicate an offset value of 340-b which may be equal to two. In the frame format 302-c, the first resource grant may indicate an offset value 340-c which may be equal to two and the second resource grant may indicate an offset value 340-d which may be equal to one. As described in FIG. 2, the offset value 340 may define a quantity of slots between PDSCH scheduled by the respective resource grants and the PUCCH 350. The UE may utilize the resources of the PUCCH 350 to transmit the feedback codebook to the base station.

The UE may receive the first resource grant and the second resource grant. In some examples, the first resource grant may be received before the second resource grant. Additionally, in some examples, the first resource grant may end in the same symbol as the second resource grant. As described herein, when generating the feedback codebook for PDSCH transmissions received over resources indicated by the SLIVs 345, the UE may consider OOO scheduling rules. For slots that have a single SLIV 345-a, the UE may generate a single ACK/NACK bit for each of the slots. For example, in the frame format 302-a, the frame format 302-b, and the frame format 302-b, the UE may generate a single ACK/NACK bit for slot n-3. For slots that have non-overlapping SLIVs 345 corresponding to different resource grants the UE may follow a set of rules. For example, in the frame format 302-a, the frame format 302-b, and the frame format 302-c, the UE may apply the set rules to the slot n-2 when generating the feedback codebook because the slot n-2 includes a SLIV 345-a and a SLIV 345-b which are non-overlapping. The process of applying the set of rules to the slot including the non-overlapping SLIVs 345 may be outlined below.

At 305, upon identifying the slot that includes non-overlapping SLIVs 345, the UE may determine whether the non-overlapping SLIVs 345 of the slot correspond to TDRA rows that each include a single SLIV 345. If the SLIVs 345 of the slot correspond to TDRA rows that include a single SLIV, the UE may proceed to 310 and generate an ACK/NACK bit for each SLIV 345 of the slot. If the SLIVs 345 of the slot do not correspond to TDRA rows that include a single SLIV, the UE may proceed to 315. In the examples of the frame format 302-a, the frame format 302-b, and the frame format 302-c, the TDRA row 0 and the TDRA row 1 do not include a single SLIV 345. As such, the UE may proceed to 315 when encountering the frame format 302-a, the frame format 302-b, and the frame format 302-c.

At 315, the UE may determine whether the earlier SLIV 345 of the slot is the last SLIV 345 of a TDRA row that includes multiple SLIVs 345. If the earlier SLIV 345 of the slot is the last SLIV 345 of the TDRA row that includes multiple SLIVs 345, the UE may proceed to 320 and generate an ACK/NACK bit for each SLIV 345 of the slot. If the earlier SLIV 345 of the slot is not the last SLIV 345 of the TDRA row that includes multiple SLIVs 345, the UE may proceed to 325. In the examples of the frame format 302-b and the frame format 302-c, the SLIV 345-a is the earlier SLIV 345 of the slot n-2 and is the last SLIV in the TDRA row 0. As such, the UE may proceed to 320 and generate two ACK/NACK bits when encountering the frame format 302-b and the frame format 302-c. In the example of the frame format 302-a, the SLIV 345-b is the earlier SLIV 345, but the TDRA row 1 does not include multiple SLIVs 345-b and thus, the SLIV 345-b of the slot n-2 cannot be the last SLIV 345 of a TDRA row that includes multiple SLIVs 345. As such, the UE may proceed to 325 when encountering the frame format 302-a.

At 325, the UE may determine whether the later SLIV in the slot is the first SLIV of a TDRA row that includes multiple SLIVs 345 and whether the earlier SLIV 345 in the slot corresponds to a TDRA row that includes a single SLIV 345. If the later SLIV in the slot is the first SLIV of a TDRA row that includes multiple SLIVs 345 and the earlier SLIV 345 in the slot corresponds to a TDRA row that includes a single SLIV 345, the UE may proceed to 330 and generate ACK/NACK bits for each SLIV 345 in the slot. If the later SLIV in the slot is not the first SLIV of a TDRA row that includes multiple SLIVs 345 or if the earlier SLIV 345 in the slot does not correspond to a TDRA row that includes a single SLIV 345, the UE may proceed to 335. In the example of the frame format 302-a, the SLIV 345-a of the slot n-2 is the later SLIV 345 of the slot n-2, but is not the first SLIV of the TDRA row 0. As such, the UE may proceed to 335 when encountering frame format 302-a.

At 335, the UE may generate a single ACK/NACK bit for the slot. The single ACK/NACK may indicate feedback information for a PDSCH transmission sent over resources allocated by the earliest resource grant. In some examples, the UE may receive the first resource before the second resource grant. In such case, in frame format 302-a, the UE may generate a single ACK/NACK bit indicating whether or not the UE received a PDSCH transmission over resources indicated by the SLIV 345-a for slot n-2.

After generating the ACK/NACK bits, the UE may transmit the feedback codebook including the ACK/NACK bits to the base station using resource of the PUCCH 350. For frame format 302-a, the UE may transmit a feedback codebook at slot n that includes two ACK/NACK bits. The two ACK/NACK bits may indicate whether the UE received PDSCH transmissions over resources indicated by the SLIVs 345-a of the slot n-3 and the slot n-2. For frame format 302-b, the UE may transmit a feedback codebook at slot n that includes three ACK/NACK bits. The three ACK/NACK bits may indicate whether the UE received PDSCH transmissions over resources indicated by the SLIVs 345-a of slot n-3 and slot n-2 and resources indicated by SLIV 345-b of the slot n-2. For frame format 302-c, the UE may transmit a feedback codebook at slot n that includes four ACK/NACK bits. The four ACK/NACK bits may indicate whether the UE received PDSCH transmissions over resources indicated by the SLIVs 345-a of slot n-3 and slot n-2 and resources indicated by the SLIV 345-b of the slot n-2 and slot n-1.

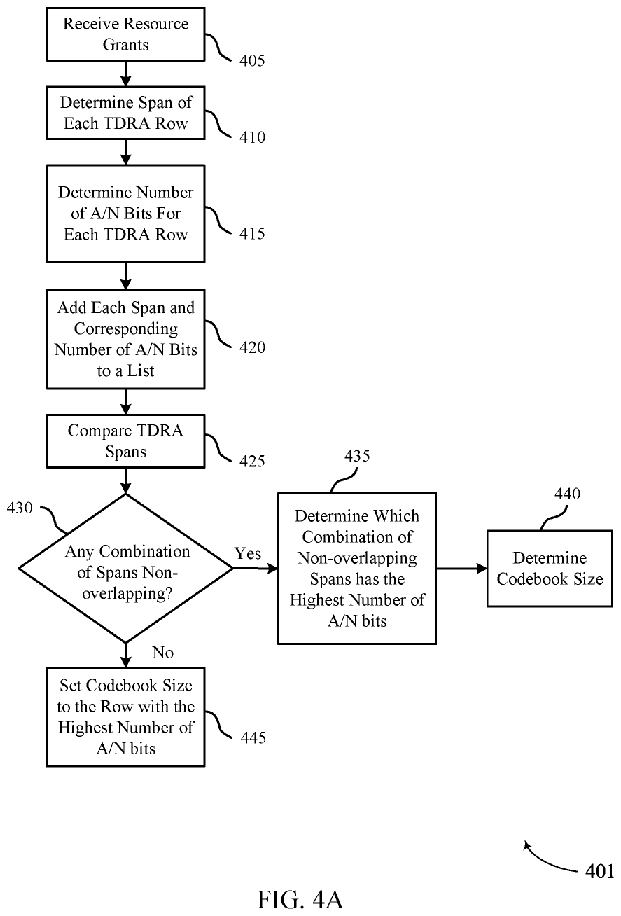

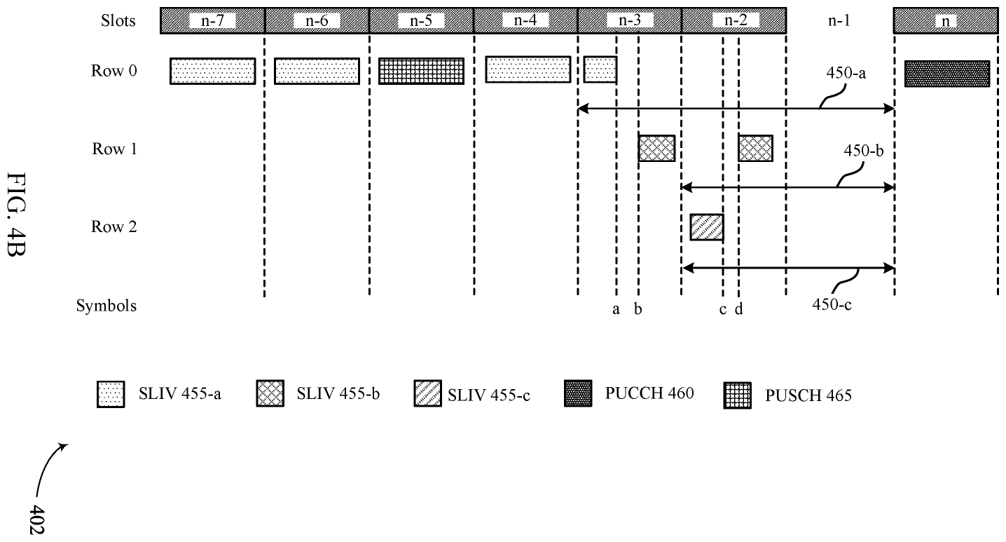

FIG. 4A illustrates an example of a flow diagram 401 that supports feedback codebook generation based on transmission scheduling rules in accordance with aspects of the present disclosure. In some examples, the flow diagram 401 may be implemented by aspects of a wireless communications system 100 and a wireless communications system 200. For example, the flow diagram 401 may be implemented by a UE 115 as described with reference to FIGS. 1 and 2.

FIG. 4B illustrates an example of a frame format 402 that supports feedback codebook generation based on transmission scheduling rules in accordance with aspects of the present disclosure. In some examples, the frame format 402 may be implemented by aspects of a wireless communications system 100 and a wireless communications system 200. For example, the frame format 402 may be implemented by a UE 115 and a base station 105 as described with reference to FIGS. 1 and 2.

As described in FIG. 2, a UE may receive multiple resource grants from a base station. A resource grant may allocate resources to the UE. The UE may utilize the resource to receive one or more PDSCH transmissions from the base station. In some examples, the resource grant may indicate a SLIV 455. The SLIV 455 may define the start symbol and a number of consecutive symbols for PDSCH allocation in a slot using a single number. In some examples, the resource grant may be an example of a multi-PDSCH resource grant or a single-PDSCH resource grant. A multi-PDSCH grant may indicate multiple SLIVs 455, whereas a single PDSCH grant may indicate a single SLIV 455.

Additionally, the resource grant may indicate an offset value 450 (e.g., K1). The offset value 450 may indicate a quantity of symbols between a last symbol used to transmit PDSCH of a corresponding resource grant and a PUCCH 460. The UE may utilize resources of the PUCCH 460 to transmit a feedback codebook (e.g., a HARQ codebook) that includes feedback information (e.g., ACK/NACK bits) related to the received PDSCH transmissions. A procedure for generating a HARQ codebook when considering OOO scheduling rules is presented below.

At 405, the UE may receive multiple resource grants. In the example of frame format 402, the UE may receive a first resource grant, a second resource grant, and a third resource grant. In some examples, the UE may receive the first resource grant prior to the second resource grant and the second resource grant prior to the third resource grant. In some examples, the first resource grant, the second resource grant, and the third resource grant may end in a same symbol. The first resource grant may correspond to TDRA row 0 and indicate SLIVs 455-a and an offset value 450-a which may be equal to three. The second resource grant may correspond to TDRA row 1 and indicate SLIVs 455-b and an offset value 450-b which may be equal to two. The third resource grant may correspond to TDRA row 2 and indicate SLIVs 455-c and an offset value 450-c which is equal may be two.

At 410, the UE may determine a TDRA span for each TDRA row. The TDRA span may be the from a first symbol of the first SLIV 455 of the TDRA row to the last symbol of the last SLIV 455 of the TDRA row. As an example, the TDRA span of the TDRA row 1 may be from the first symbol of slot n-7 to symbol a of slot n-3, the TDRA span of the TDRA row 1 may be from symbol b of slot n-3 to the last symbol of slot n-2, and the TDRA span of the TDRA row 2 may be from the first symbol of slot n-2 to symbol c of slot n-2. The symbol a may come before the symbol b in time in the slot n-3 and the symbol c may come before the symbol d in time in the slot n-2.

At 415, the UE may determine a total quantity of ACK/NACK bits to include in a feedback codebook for each TDRA row. As an example, the total number of ACK/NACK bits for TDRA row 0 may be four ACK/NACK bits, the total number of ACK/NACK bits for the TDRA row 1 may be two ACK/NACK bits, and the total number of ACK/NACK bits for the TDRA row 2 may be two ACK/NACK bits. In some examples, a portion of the slots may be reserved for uplink transmissions (e.g., physical uplink shared channel (PUSCH) transmissions). For example, slot n-5 may be reserved for PUSCH 465. If a slot is reserved for PUSCH 465, the UE may not expect a PDSCH transmission in the slot and as such, a ACK/NACK bit may not be generated for the slot. Therefore, the total number of ACK/NACK bits for TDRA row 0 is four instead of five.

At 420, the UE may add (e.g., in a table) each of the TDRA spans and each corresponding total quantity of ACK/NACK bits to a list. In some examples, the UE may store the list in its memory.

At 425, the UE may compare the TDRA spans and determine if any combinations of the TDRA spans are non-overlapping. If the UE determine that at least one combination of the TDRA spans do not overlap, the UE may proceed to 435. If the UE determines that there is no combination of the TDRA spans that are non-overlapping, the UE may proceed to 445. In the example of the frame format 402, the UE may determine that the combination of the TDRA span of TDRA row 0 and the TDRA span of TDRA row 1 do not overlap. In addition, the UE may determine that the combination of the TDRA span of TDRA row 0 and the TDRA span of TDRA row 2 do not overlap. As such, the UE may proceed to 435 when encountering frame format 402.

At 435, the UE may determine which combination of non-overlapping rows has a highest quantity of ACK/NACK bits. For each combination of non-overlapping TDRA spans, the UE may add the total number of ACK/NACK bits for each span in the combination together. For example, the UE may determine that the combination of the TDRA span for TDRA row 0 and the TDRA span for TDRA row 1 has a total of six ACK/NACK bits and the combination of the TDRA span for TDRA row 0 and the TDRA span for TDRA row 1 has a total of five ACK/NACK bits. The UE may select the combination that has the highest quantity of bits. For example, the UE may select the combination of TDRA row 0 and TDRA row 1.

At 440, the UE may determine the feedback codebook size. In some examples, the feedback codebook size may be equal to the highest quantity of ACK/NACK bits determined at 435. For example, the UE may set the codebook size equal to six.

At 445, the UE may not determine any non-overlapping spans and may set the codebook size to a highest total quantity of ACK/NACK bits of all of the TDRA spans.

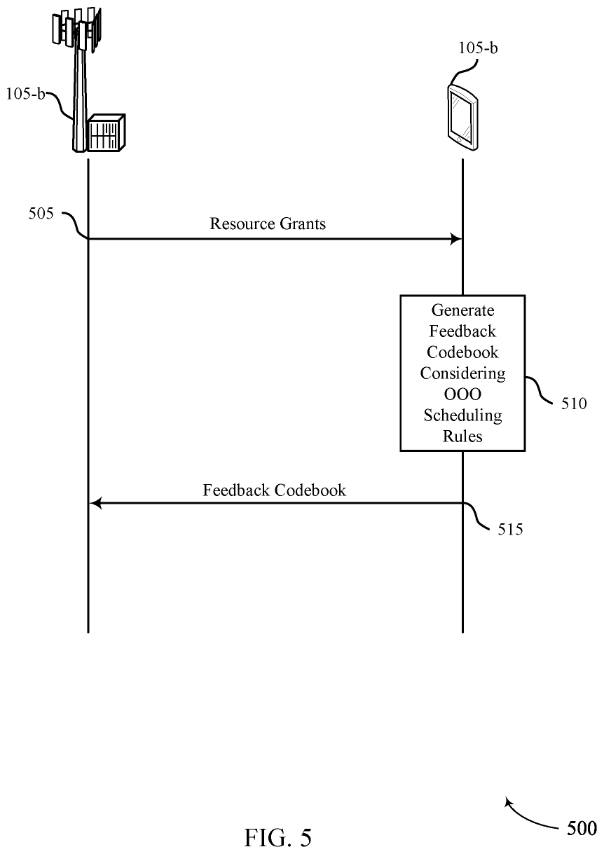

FIG. 5 illustrates an example of a process flow 500 that supports feedback codebook generation based on transmission scheduling rules in accordance with aspects of the present disclosure. In some examples, the process flow 500 may implement aspects of a wireless communications system 100 and a wireless communications system 200. For example, the process flow 500 may be implemented by a UE 115-b and a base station 105-b which may be examples of a UE 115 and a base station 105 as described with reference to FIGS. 1 and 2. Alternative examples of the following may be implemented, where some steps are performed in a different order than described or are not performed at all. In some cases, steps may include additional features not mentioned below, or further steps may be added.

At 505, the base station 105-b may transmit resource grants to the UE 115-b. As one example, the base station 105-b may transmit a first resource grant allocating a first set of downlink resources to the UE 115-b for a PDSCH transmission and a second resource grant allocating a second set of downlink resources to the UE 115-b for a PDSCH transmission. In some examples, the resource grants may be transmitted via downlink control information (DCI). The resource grants may be single-PDSCH scheduling DCIs or multi-PDSCH scheduling DCIs. A single-PDSCH scheduling DCI may schedule a single PDSCH. That is, the resources allocated by the single PDSCH scheduling DCI may span in a single slot. A multi-PDSCH scheduling DCI may schedule multiple PDSCHs. That is, the resources allocated by the multi-PDSCH may span multiple slots. The first resource grant may be received prior to the second resource grant and in some examples, the first resource grant and the second resource grant may end in a same symbol.

At 510, the UE 115-b may generate a feedback codebook for downlink signaling scheduled to be received over resource allocated by the resource grants received at 505. In some examples, the feedback codebook may be a HARQ type-1 codebook. As described herein, the UE may account for OOO rules when generating the feedback codebook. In one example, the UE may generate feedback bits for the feedback codebook based on a set of rules. The set of rules may instruct the UE 115-b on how to generate feedback bits for slots that include non-overlapping resources allocated by different resource grants. The UE 115-b may determine that a slot includes resources of the first set of downlink resources and resources of the second set of downlink resources. In addition, the UE may determine that the resources of the first set of downlink resources do not overlap the resources of the second set of downlink resources in a time domain. Once the UE 115-b locates the slot of non-overlapping resources, the UE 115-b may apply the set of rules to determine how many feedback bits to generate for the slot.

The set of rules may specify to generate a single feedback bit for the PDSCH transmission scheduled to be received over resources of the first set of downlink resources unless the first set of resources is entirely within the slot and the second set of resources is entirely within the slot. If this condition is met, the UE 115-b may generate a feedback bit for the PDSCH transmission scheduled to be received over the resource of the first set of downlink resources and a PDSCH bit for a PDSCH transmission scheduled to be received over the resource of the second set of downlink resources for the slot.

In some examples, the resources of the first set of downlink resources may be earlier in the slot than the resources of the second set of downlink resources. In such example, the set of rules may also specify to generate a single feedback bit for a PDSCH transmission scheduled to be received over the resources of the first set of downlink resources unless the first set of downlink resources spans multiple slots and a last slot of the multiple slots is the slot. If this condition is met, the UE 115-b may generate a feedback bit for the PDSCH transmission scheduled to be received over the resource of the first set of downlink resources and a PDSCH bit for a PDSCH transmission scheduled to be received over the resources of the second set of downlink resources for the slot.

The set of rules may also specify to generate a single feedback bit for a PDSCH transmission scheduled to be received over the resource of the first set of downlink resources unless the first set of resources is entirely within the slot and the second set of downlink resources spans multiple slots and a first slot of the multiple slots includes the slot. If this condition is met, the UE 115-b may generate a feedback bit for the PDSCH transmission scheduled to be received over the resource of the first set of downlink resources and a PDSCH bit for a PDSCH transmission scheduled to be received over the resources of the second set of downlink resources for the slot.

Alternatively, the UE 115-b may generate the feedback codebook using a procedure that considers OOO scheduling rules. The UE 115-b may determine a first quantity of feedback bits to include in the feedback codebook for PDSCH signaling received over the first set of downlink resources and a second quantity of feedback bits to include in the feedback for PDSCH signaling received over the second set of downlink resources. The UE 115-b may then determine whether the first set of downlink resource do not overlap the second set of downlink resources in a time domain. If the first set of downlink resources do not overlap the second set of downlink resources, the UE 115-b may combine the first quantity of feedback bits and the second quantity of bits to determine a size of the codebook size. That is, the UE 115-b may add the first quantity of feedback bits and the second quantity of feedback bits together and set the sum equal to the codebook size. Alternatively, if the UE 115-b determines that the first set of downlink resources overlaps the second set of downlink resources, the UE 115-b may set the size of feedback codebook equal to the first quantity of feedback bits.

In some examples, the UE 115-b may receive a third resource grant that allocates a third set of downlink resources to the UE 115-b for a PDSCH transmission. In some examples, the UE 115-b may determine that the third set of downlink resources do not overlap the first set of downlink resources in the time domain. In such example, the UE 115-b may consider different combinations of non-overlapping resources when determining the feedback codebook size. That is, the UE 115-b may determine a third quantity of feedback bits to include in the feedback codebook for PDSCH signaling received over the third set of resources and add the third quantity of feedback bits and the first quantity of feedback bits together. The UE 115-b may compare the two sums (e.g., the sum of the first quantity of feedback bits and the second quantity of feedback bits and the sum of the first quantity of bits and the third quantity of feedback bits) and select the highest of the two sums. The UE 115-b may set the codebook size equal to the highest sum.

At 515, the UE 115-b may transmit the feedback codebook to the base station 105-b. Using the methods as described above may allow the UE 115-b to decrease the size of the feedback codebook when OOO scheduling rules are satisfied which may allow for more efficient use of communication resources (e.g., PUCCH resources).

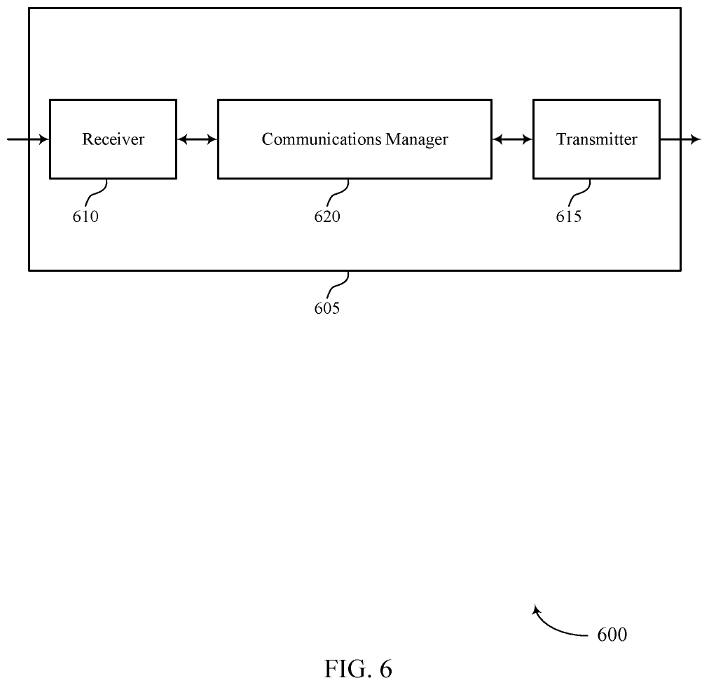

FIG. 6 shows a block diagram 600 of a device 605 that supports feedback codebook generation based on transmission scheduling rules in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to feedback codebook generation based on transmission scheduling rules). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to feedback codebook generation based on transmission scheduling rules). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of feedback codebook generation based on transmission scheduling rules as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, from a base station, a first grant allocating a first set of downlink resources to the UE. The communications manager 620 may be configured as or otherwise support a means for receiving, from the base station and after receiving the first grant, a second grant allocating a second set of downlink resources to the UE. The communications manager 620 may be configured as or otherwise support a means for determining that a slot includes both resources of the first set of downlink resources and resources of the second set of downlink resources. The communications manager 620 may be configured as or otherwise support a means for generating a feedback codebook for downlink signaling scheduled to be received over the first set of downlink resources, the second set of downlink resources, or both, where a size of the feedback codebook is based on the slot including both resources of the first set of downlink resources and resources of the second set of downlink resources. The communications manager 620 may be configured as or otherwise support a means for transmitting, to the base station, the feedback codebook based on generating the feedback codebook.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing and more efficient utilization of communication resources. As described herein, the device 605 may reduce a size of a feedback codebook when OOO scheduling rules are met which may allow the device 605 to allocate less resources for transmission of the feedback codebook and increase a coding rate at the device 605.

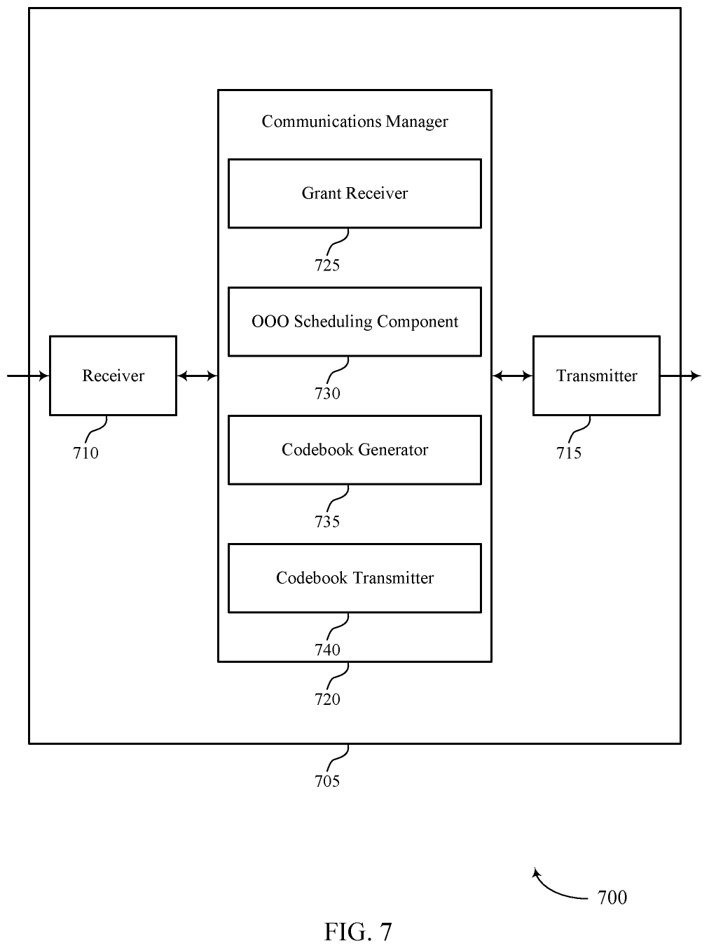

FIG. 7 shows a block diagram 700 of a device 705 that supports feedback codebook generation based on transmission scheduling rules in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to feedback codebook generation based on transmission scheduling rules). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to feedback codebook generation based on transmission scheduling rules). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of feedback codebook generation based on transmission scheduling rules as described herein. For example, the communications manager 720 may include a grant receiver 725, a OOO scheduling component 730, a codebook generator 735, a codebook transmitter 740, or any combination thereof The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The grant receiver 725 may be configured as or otherwise support a means for receiving, from a base station, a first grant allocating a first set of downlink resources to the UE. The grant receiver 725 may be configured as or otherwise support a means for receiving, from the base station and after receiving the first grant, a second grant allocating a second set of downlink resources to the UE. The OOO scheduling component 730 may be configured as or otherwise support a means for determining that a slot includes both resources of the first set of downlink resources and resources of the second set of downlink resources. The codebook generator 735 may be configured as or otherwise support a means for generating a feedback codebook for downlink signaling scheduled to be received over the first set of downlink resources, the second set of downlink resources, or both, where a size of the feedback codebook is based on the slot including both resources of the first set of downlink resources and resources of the second set of downlink resources. The codebook transmitter 740 may be configured as or otherwise support a means for transmitting, to the base station, the feedback codebook based on generating the feedback codebook.

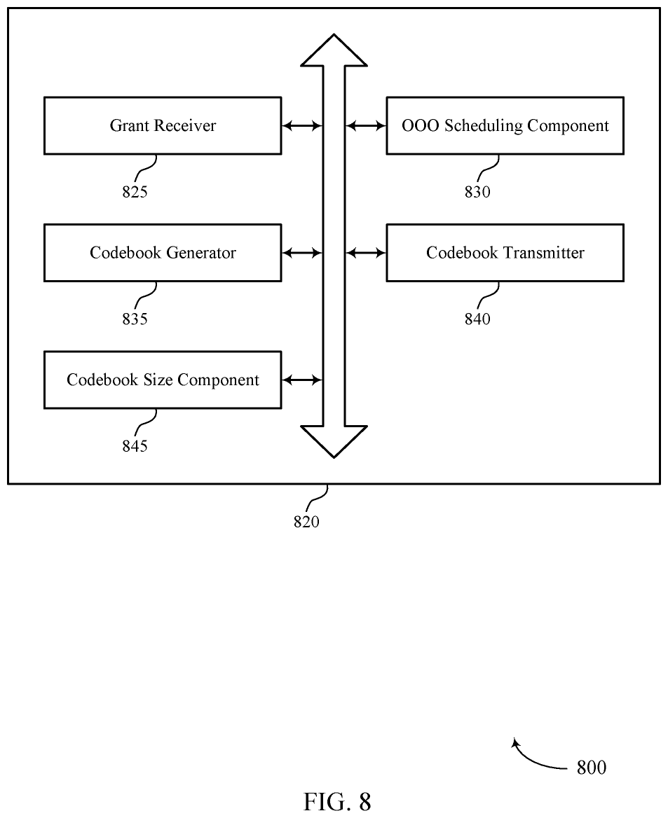

FIG. 8 shows a block diagram 800 of a communications manager 820 that supports feedback codebook generation based on transmission scheduling rules in accordance with aspects of the present disclosure. The communications manager 820 may be an example of aspects of a communications manager 620, a communications manager 720, or both, as described herein. The communications manager 820, or various components thereof, may be an example of means for performing various aspects of feedback codebook generation based on transmission scheduling rules as described herein. For example, the communications manager 820 may include a grant receiver 825, a OOO scheduling component 830, a codebook generator 835, a codebook transmitter 840, a codebook size component 845, or any combination thereof. Each of these components may communicate, directly or indirectly, with one another (e.g., via one or more buses).

The communications manager 820 may support wireless communication at a UE in accordance with examples as disclosed herein. The grant receiver 825 may be configured as or otherwise support a means for receiving, from a base station, a first grant allocating a first set of downlink resources to the UE. In some examples, the grant receiver 825 may be configured as or otherwise support a means for receiving, from the base station and after receiving the first grant, a second grant allocating a second set of downlink resources to the UE. The OOO scheduling component 830 may be configured as or otherwise support a means for determining that a slot includes both resources of the first set of downlink resources and resources of the second set of downlink resources. The codebook generator 835 may be configured as or otherwise support a means for generating a feedback codebook for downlink signaling scheduled to be received over the first set of downlink resources, the second set of downlink resources, or both, where a size of the feedback codebook is based on the slot including both resources of the first set of downlink resources and resources of the second set of downlink resources. The codebook transmitter 840 may be configured as or otherwise support a means for transmitting, to the base station, the feedback codebook based on generating the feedback codebook.

In some examples, the OOO scheduling component 830 may be configured as or otherwise support a means for determining, based on determining that the slot includes the resources of the first set of downlink resources and the resources of the second set of downlink resources, whether the resources of the first set of downlink resources are earlier in the slot than the resources of the second set of downlink resources, wherein the size of the feedback codebook is further based on whether the resources of the first set of downlink resources are earlier in the slot than the resources of the second set of downlink resources.

In some examples, to support generating the feedback codebook, the codebook generator 835 may be configured as or otherwise support a means for generating a single feedback bit for the slot based on determining that the resources of the first set of downlink resources are not earlier in the slot than the resources of the second set of downlink resources.

In some examples, to support generating the feedback codebook, the codebook generator 835 may be configured as or otherwise support a means for generating at least two feedback bits for the slot based on determining that the resources of the first set of downlink resources are earlier in the slot than the resources of the second set of downlink resources.

In some examples, the first set of downlink resources spans a set of multiple slots and a last slot of set of multiple slots includes the slot.

In some examples, the first set of downlink resources is entirely within the slot and the second set of downlink resources spans a set of multiple slots. In some examples, a first slot of the set of multiple slots includes the slot.

In some examples, the OOO scheduling component 830 may be configured as or otherwise support a means for determining that the first set of downlink resources and the second set of downlink resources are both entirely within the slot. In some examples, the codebook generator 835 may be configured as or otherwise support a means for generating the codebook at least in part by generating at least two feedback bits for the slot based on determining that the first set of downlink resources and the second set of downlink resources are both entirely within the slot.

In some examples, the codebook size component 845 may be configured as or otherwise support a means for determining the size of the feedback codebook based on the slot including both resources of the first set of downlink resources and resources of the second set of downlink resources.

In some examples, to support determining the size of the feedback codebook, the codebook size component 845 may be configured as or otherwise support a means for determining a first quantity of feedback bits to include in the feedback codebook for scheduled downlink signaling on the first set of downlink resources. In some examples, to support determining the size of the feedback codebook, the codebook size component 845 may be configured as or otherwise support a means for determining a second quantity of feedback bits to include in the feedback codebook for scheduled downlink signaling on the second set of downlink resources. In some examples, to support determining the size of the feedback codebook, the codebook size component 845 may be configured as or otherwise support a means for determining a maximum quantity of feedback bits for the feedback codebook based on the first quantity of feedback bits and the second quantity of feedback bits, the size of the feedback codebook equal to the maximum quantity of feedback bits.

In some examples, to support determining the maximum quantity of feedback bits, the codebook size component 845 may be configured as or otherwise support a means for determining that the first set of downlink resources and the second set of downlink resources do not overlap one another in a time domain. In some examples, to support determining the maximum quantity of feedback bits, the codebook size component 845 may be configured as or otherwise support a means for determining a third quantity of feedback bits, where the third quantity of feedback bits corresponds to a combination of the first quantity of feedback bits and the second quantity of feedback bits, and where the third quantity of feedback bits is equal to the maximum quantity of feedback bits.

In some examples, the grant receiver 825 may be configured as or otherwise support a means for receiving, from the base station, a third grant allocating a third set of downlink resources to the UE. In some examples, the codebook size component 845 may be configured as or otherwise support a means for determining a fourth quantity of feedback bits to include in the feedback codebook for scheduled downlink signaling on the third set of downlink resources. In some examples, the codebook size component 845 may be configured as or otherwise support a means for determining that the third set of downlink resources and the first set of downlink resources do not overlap one another in a time domain. In some examples, the codebook size component 845 may be configured as or otherwise support a means for determining a fifth quantity of feedback bits, where the fifth quantity of feedback bits corresponds to a combination of the first quantity of feedback bits and the fourth quantity of feedback bits, and where the maximum quantity of feedback bits is equal to the third quantity of feedback bits based on the fifth quantity of feedback bits being less than the third quantity of feedback bits.

In some examples, the first grant and the second grant each include multi-physical downlink shared channel scheduling DCI or single-physical downlink shared channel scheduling DCI. In some examples, the feedback codebook includes a type-1 HARQ codebook.

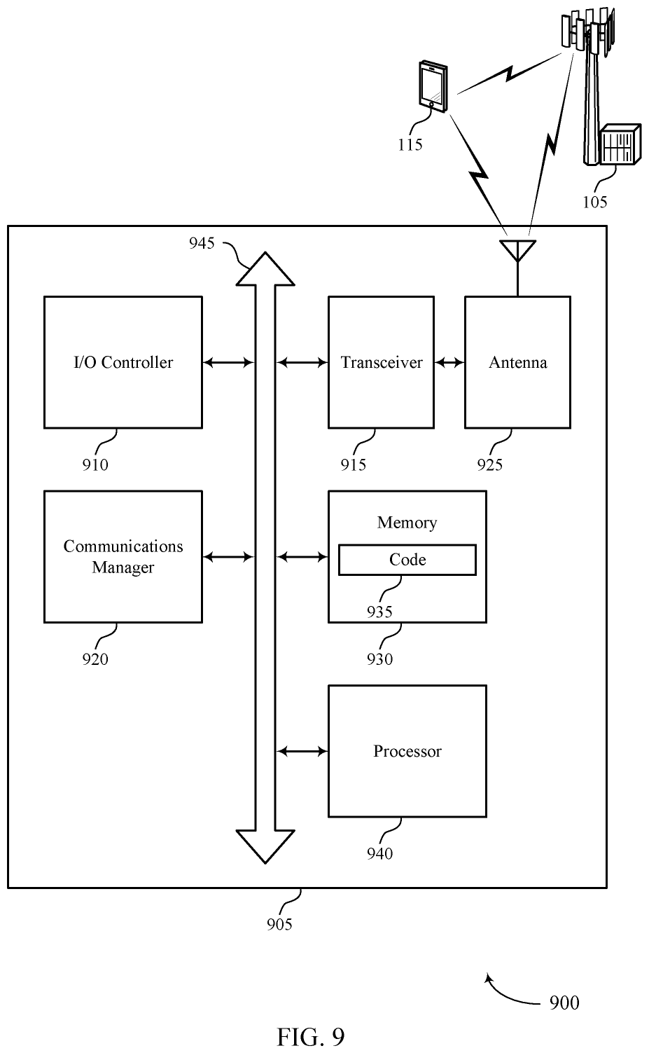

FIG. 9 shows a diagram of a system 900 including a device 905 that supports feedback codebook generation based on transmission scheduling rules in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting feedback codebook generation based on transmission scheduling rules). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a base station, a first grant allocating a first set of downlink resources to the UE. The communications manager 920 may be configured as or otherwise support a means for receiving, from the base station and after receiving the first grant, a second grant allocating a second set of downlink resources to the UE. The communications manager 920 may be configured as or otherwise support a means for determining that a slot includes both resources of the first set of downlink resources and resources of the second set of downlink resources. The communications manager 920 may be configured as or otherwise support a means for generating a feedback codebook for downlink signaling scheduled to be received over the first set of downlink resources, the second set of downlink resources, or both, where a size of the feedback codebook is based on the slot including both resources of the first set of downlink resources and resources of the second set of downlink resources. The communications manager 920 may be configured as or otherwise support a means for transmitting, to the base station, the feedback codebook based on generating the feedback codebook.

By including or configuring the communications manager 920 in accordance with examples as described herein, the device 905 may support techniques for reduced processing and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of feedback codebook generation based on transmission scheduling rules as described herein, or the processor 940 and the memory 930 may be otherwise configured to perform or support such operations.

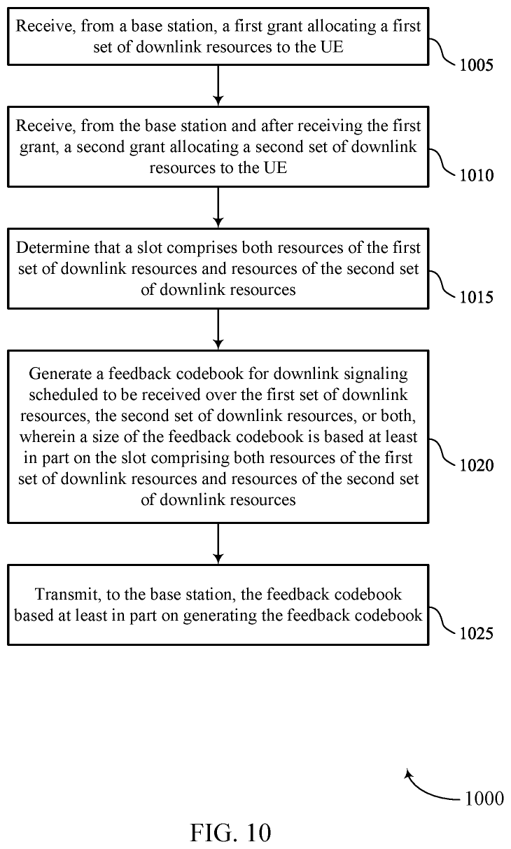

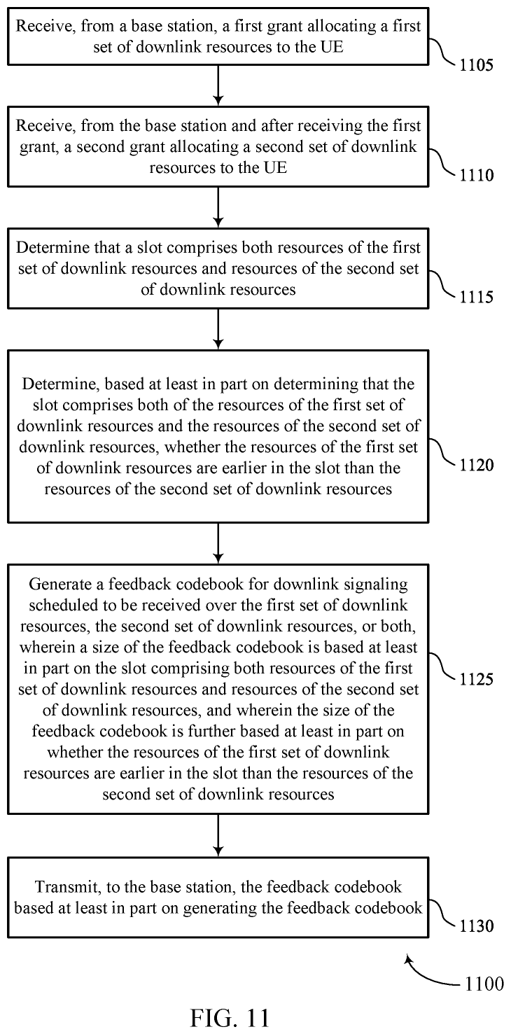

FIG. 10 shows a flowchart illustrating a method 1000 that supports feedback codebook generation based on transmission scheduling rules in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1005, the method may include receiving, from a base station, a first grant allocating a first set of downlink resources to the UE. The operations of 1005 may be performed in accordance with examples as disclosed herein. In some examples, aspects of the operations of 1005 may be performed by a grant receiver 825 as described with reference to FIG. 8. Additionally or alternatively, means for performing 1005 may, but not necessarily, include, for example, antenna 925, transceiver 915, communications manager 920, memory 930 (including code 935), processor 940 and/or bus 945.

At 1010, the method may include receiving, from the base station and after receiving the first grant, a second grant allocating a second set of downlink resources to the UE. The operations of 1010 may be performed in accordance with examples as disclosed herein. In some examples, aspects of the operations of 1010 may be performed by a grant receiver 825 as described with reference to FIG. 8. Additionally or alternatively, means for performing 1010 may, but not necessarily, include, for example, antenna 925, transceiver 915, communications manager 920, memory 930 (including code 935), processor 940 and/or bus 945.

At 1015, the method may include determining that a slot includes both resources of the first set of downlink resources and resources of the second set of downlink resources. The operations of 1015 may be performed in accordance with examples as disclosed herein. In some examples, aspects of the operations of 1015 may be performed by a OOO scheduling component 830 as described with reference to FIG. 8. Additionally or alternatively, means for performing 1015 may, but not necessarily, include, for example, antenna 925, transceiver 915, communications manager 920, memory 930 (including code 935), processor 940 and/or bus 945.

At 1020, the method may include generating a feedback codebook for downlink signaling scheduled to be received over the first set of downlink resources, the second set of downlink resources, or both, where a size of the feedback codebook is based on the slot including both resources of the first set of downlink resources and resources of the second set of downlink resources. The operations of 1020 may be performed in accordance with examples as disclosed herein. In some examples, aspects of the operations of 1020 may be performed by a codebook generator 835 as described with reference to FIG. 8. Additionally or alternatively, means for performing 1020 may, but not necessarily, include, for example, antenna 925, transceiver 915, communications manager 920, memory 930 (including code 935), processor 940 and/or bus 945.

At 1025, the method may include transmitting, to the base station, the feedback codebook based on generating the feedback codebook. The operations of 1025 may be performed in accordance with examples as disclosed herein. In some examples, aspects of the operations of 1025 may be performed by a codebook transmitter 840 as described with reference to FIG. 8. Additionally or alternatively, means for performing 1025 may, but not necessarily, include, for example, antenna 925, transceiver 915, communications manager 920, memory 930 (including code 935), processor 940 and/or bus 945.

FIG. 11 shows a flowchart illustrating a method 1100 that supports feedback codebook generation based on transmission scheduling rules in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1105, the method may include receiving, from a base station, a first grant allocating a first set of downlink resources to the UE. The operations of 1105 may be performed in accordance with examples as disclosed herein. In some examples, aspects of the operations of 1105 may be performed by a grant receiver 825 as described with reference to FIG. 8. Additionally or alternatively, means for performing 1105 may, but not necessarily, include, for example, antenna 925, transceiver 915, communications manager 920, memory 930 (including code 935), processor 940 and/or bus 945.

At 1110, the method may include receiving, from the base station and after receiving the first grant, a second grant allocating a second set of downlink resources to the UE. The operations of 1110 may be performed in accordance with examples as disclosed herein. In some examples, aspects of the operations of 1110 may be performed by a grant receiver 825 as described with reference to FIG. 8. Additionally or alternatively, means for performing 1110 may, but not necessarily, include, for example, antenna 925, transceiver 915, communications manager 920, memory 930 (including code 935), processor 940 and/or bus 945.

At 1115, the method may include determining that a slot includes both resources of the first set of downlink resources and resources of the second set of downlink resources. The operations of 1115 may be performed in accordance with examples as disclosed herein. In some examples, aspects of the operations of 1115 may be performed by a OOO scheduling component 830 as described with reference to FIG. 8. Additionally or alternatively, means for performing 1115 may, but not necessarily, include, for example, antenna 925, transceiver 915, communications manager 920, memory 930 (including code 935), processor 940 and/or bus 945.

At 1120, the method may include determining, based on determining that the slot includes both the resources of the first set of downlink resources and the resources of the second set of downlink resources, whether the resources of the first set of downlink resources are earlier in the slot than the resources of the second set of downlink resources. The operations of 1120 may be performed in accordance with examples as disclosed herein. In some examples, aspects of the operations of 1120 may be performed by a OOO scheduling component 830 as described with reference to FIG. 8. Additionally or alternatively, means for performing 1120 may, but not necessarily, include, for example, antenna 925, transceiver 915, communications manager 920, memory 930 (including code 935), processor 940 and/or bus 945.

At 1125, the method may include generating a feedback codebook for downlink signaling scheduled to be received over the first set of downlink resources, the second set of downlink resources, or both, where a size of the feedback codebook is based on the slot including both resources of the first set of downlink resources and resources of the second set of downlink resources, and where the size of the feedback codebook is further based on whether the resources of the first set of downlink resources are earlier in the slot than the resources of the second set of downlink resources. The operations of 1125 may be performed in accordance with examples as disclosed herein. In some examples, aspects of the operations of 1125 may be performed by a codebook generator 835 as described with reference to FIG. 8. Additionally or alternatively, means for performing 1125 may, but not necessarily, include, for example, antenna 925, transceiver 915, communications manager 920, memory 930 (including code 935), processor 940 and/or bus 945.

At 1130, the method may include transmitting, to the base station, the feedback codebook based on generating the feedback codebook. The operations of 1130 may be performed in accordance with examples as disclosed herein. In some examples, aspects of the operations of 1130 may be performed by a codebook transmitter 840 as described with reference to FIG. 8. Additionally or alternatively, means for performing 1130 may, but not necessarily, include, for example, antenna 925, transceiver 915, communications manager 920, memory 930 (including code 935), processor 940 and/or bus 945.

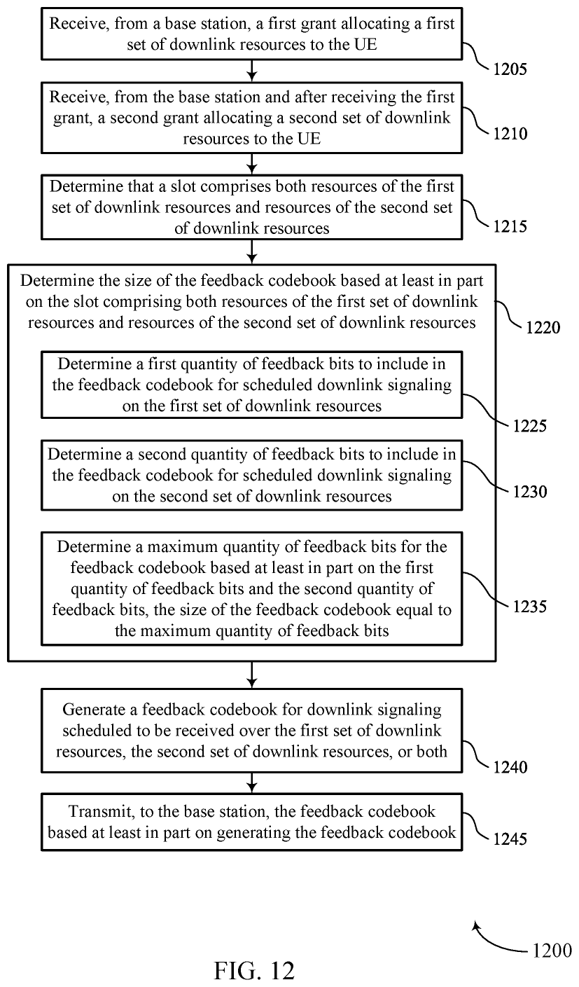

FIG. 12 shows a flowchart illustrating a method 1200 that supports feedback codebook generation based on transmission scheduling rules in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1205, the method may include receiving, from a base station, a first grant allocating a first set of downlink resources to the UE. The operations of 1205 may be performed in accordance with examples as disclosed herein. In some examples, aspects of the operations of 1205 may be performed by a grant receiver 825 as described with reference to FIG. 8. Additionally or alternatively, means for performing 1205 may, but not necessarily, include, for example, antenna 925, transceiver 915, communications manager 920, memory 930 (including code 935), processor 940 and/or bus 945.

At 1210, the method may include receiving, from the base station and after receiving the first grant, a second grant allocating a second set of downlink resources to the UE. The operations of 1210 may be performed in accordance with examples as disclosed herein. In some examples, aspects of the operations of 1210 may be performed by a grant receiver 825 as described with reference to FIG. 8. Additionally or alternatively, means for performing 1210 may, but not necessarily, include, for example, antenna 925, transceiver 915, communications manager 920, memory 930 (including code 935), processor 940 and/or bus 945.

At 1215, the method may include determining that a slot includes both resources of the first set of downlink resources and resources of the second set of downlink resources. The operations of 1215 may be performed in accordance with examples as disclosed herein. In some examples, aspects of the operations of 1215 may be performed by a OOO scheduling component 830 as described with reference to FIG. 8. Additionally or alternatively, means for performing 1215 may, but not necessarily, include, for example, antenna 925, transceiver 915, communications manager 920, memory 930 (including code 935), processor 940 and/or bus 945.

At 1220, the method may include determining the size of the feedback codebook based on the slot including both resources of the first set of downlink resources and resources of the second set of downlink resources. The operations of 1220 may be performed in accordance with examples as disclosed herein. In some examples, the operations of 1220 may include the operations of 1225, 1230, and 1235. In some examples, aspects of the operations of 1220 may be performed by a codebook size component 845 as described with reference to FIG. 8. Additionally or alternatively, means for performing 1220 may, but not necessarily, include, for example, antenna 925, transceiver 915, communications manager 920, memory 930 (including code 935), processor 940 and/or bus 945.

At 1225, the method may include determining a first quantity of feedback bits to include in the feedback codebook for scheduled downlink signaling on the first set of downlink resources. The operations of 1225 may be performed in accordance with examples as disclosed herein. In some examples, aspects of the operations of 1225 may be performed by a codebook size component 845 as described with reference to FIG. 8. Additionally or alternatively, means for performing 1225 may, but not necessarily, include, for example, antenna 925, transceiver 915, communications manager 920, memory 930 (including code 935), processor 940 and/or bus 945.

At 1230, the method may include determining a second quantity of feedback bits to include in the feedback codebook for scheduled downlink signaling on the second set of downlink resources. The operations of 1230 may be performed in accordance with examples as disclosed herein. In some examples, aspects of the operations of 1230 may be performed by a codebook size component 845 as described with reference to FIG. 8. Additionally or alternatively, means for performing 1230 may, but not necessarily, include, for example, antenna 925, transceiver 915, communications manager 920, memory 930 (including code 935), processor 940 and/or bus 945.

At 1235, the method may include determining a maximum quantity of feedback bits for the feedback codebook based on the first quantity of feedback bits and the second quantity of feedback bits, the size of the feedback codebook equal to the maximum quantity of feedback bits. The operations of 1235 may be performed in accordance with examples as disclosed herein. In some examples, aspects of the operations of 1235 may be performed by a codebook size component 845 as described with reference to FIG. 8. Additionally or alternatively, means for performing 1235 may, but not necessarily, include, for example, antenna 925, transceiver 915, communications manager 920, memory 930 (including code 935), processor 940 and/or bus 945.

At 1240, the method may include generating a feedback codebook for downlink signaling scheduled to be received over the first set of downlink resources, the second set of downlink resources, or both. The operations of 1240 may be performed in accordance with examples as disclosed herein. In some examples, aspects of the operations of 1240 may be performed by a codebook generator 835 as described with reference to FIG. 8. Additionally or alternatively, means for performing 1240 may, but not necessarily, include, for example, antenna 925, transceiver 915, communications manager 920, memory 930 (including code 935), processor 940 and/or bus 945.

At 1245, the method may include transmitting, to the base station, the feedback codebook based on generating the feedback codebook. The operations of 1245 may be performed in accordance with examples as disclosed herein. In some examples, aspects of the operations of 1245 may be performed by a codebook transmitter 840 as described with reference to FIG. 8. Additionally or alternatively, means for performing 1245 may, but not necessarily, include, for example, antenna 925, transceiver 915, communications manager 920, memory 930 (including code 935), processor 940 and/or bus 945.

The following provides an overview of aspects of the present disclosure:

Aspect 1: A method for wireless communication at a UE, comprising: receiving, from a base station, a first grant allocating a first set of downlink resources to the UE; receiving, from the base station and after receiving the first grant, a second grant allocating a second set of downlink resources to the UE; determining that a slot comprises both resources of the first set of downlink resources and resources of the second set of downlink resources; generating a feedback codebook for downlink signaling scheduled to be received over the first set of downlink resources, the second set of downlink resources, or both, wherein a size of the feedback codebook is based at least in part on the slot comprising both resources of the first set of downlink resources and resources of the second set of downlink resources; and transmitting, to the base station, the feedback codebook based at least in part on generating the feedback codebook.

Aspect 2: The method of aspect 1, further comprising: determining, based at least in part on determining that the slot comprises both the resources of the first set of downlink resources and the resources of the second set of downlink resources, whether the resources of the first set of downlink resources are earlier in the slot than the resources of the second set of downlink resources, wherein the size of the feedback codebook is further based at least in part on whether the resources of the first set of downlink resources are earlier in the slot than the resources of the second set of downlink resources.

Aspect 3: The method of aspect 2, wherein generating the feedback codebook comprises: generating a single feedback bit for the slot based at least in part on determining that the resources of the first set of downlink resources are not earlier in the slot than the resources of the second set of downlink resources.

Aspect 4: The method of any of aspects 2 through 3, wherein generating the feedback codebook comprises: generating at least two feedback bits for the slot based at least in part on determining that the resources of the first set of downlink resources are earlier in the slot than the resources of the second set of downlink resources.

Aspect 5: The method of aspect 4, wherein the first set of downlink resources spans a plurality of slots and a last slot of plurality of slots comprises the slot.

Aspect 6: The method of any of aspects 4 through 5, wherein the first set of downlink resources is entirely within the slot and the second set of downlink resources spans a plurality of slots, a first slot of the plurality of slots comprising the slot.

Aspect 7: The method of any of aspects 1 through 4, further comprising: determining that the first set of downlink resources and the second set of downlink resources are both entirely within the slot, wherein generating the feedback codebook comprises generating at least two feedback bits for the slot based at least in part on determining that the first set of downlink resources and the second set of downlink resources are both entirely within the slot.

Aspect 8: The method of any of aspects 1 through 7, further comprising: determining the size of the feedback codebook based at least in part on the slot comprising both resources of the first set of downlink resources and resources of the second set of downlink resources.

Aspect 9: The method of aspect 8, wherein determining the size of the feedback codebook comprises: determining a first quantity of feedback bits to include in the feedback codebook for scheduled downlink signaling on the first set of downlink resources; determining a second quantity of feedback bits to include in the feedback codebook for scheduled downlink signaling on the second set of downlink resources; and determining a maximum quantity of feedback bits for the feedback codebook based at least in part on the first quantity of feedback bits and the second quantity of feedback bits, the size of the feedback codebook equal to the maximum quantity of feedback bits.

Aspect 10: The method of aspect 9, wherein determining the maximum quantity of feedback bits comprises: determining that the first set of downlink resources and the second set of downlink resources do not overlap one another in a time domain; and determining a third quantity of feedback bits, wherein the third quantity of feedback bits corresponds to a combination of the first quantity of feedback bits and the second quantity of feedback bits, and wherein the third quantity of feedback bits is equal to the maximum quantity of feedback bits.

Aspect 11: The method of aspect 10, further comprising: receiving, from the base station, a third grant allocating a third set of downlink resources to the UE; determining a fourth quantity of feedback bits to include in the feedback codebook for scheduled downlink signaling on the third set of downlink resources; determining that the third set of downlink resources and the first set of downlink resources do not overlap one another in a time domain; and determining a fifth quantity of feedback bits, wherein the fifth quantity of feedback bits corresponds to a combination of the first quantity of feedback bits and the fourth quantity of feedback bits, and wherein the maximum quantity of feedback bits is equal to the third quantity of feedback bits based at least in part on the fifth quantity of feedback bits being less than the third quantity of feedback bits.

Aspect 12: The method of any of aspects 1 through 11, wherein the first grant and the second grant each comprise multi-PDSCH scheduling DCI or single-PDSCH scheduling DCI.

Aspect 13: The method of any of aspects 1 through 12, wherein the feedback codebook comprises a type-1 HARQ codebook.

Aspect 14: An apparatus for wireless communication at a UE, comprising a memory, a transceiver, and at least one processor coupled with the memory and the transceiver, the at least one processor configured to cause the apparatus to perform a method of any of aspects 1 through 13.

Aspect 15: An apparatus for wireless communication at a UE, comprising at least one means for performing a method of any of aspects 1 through 13.

Aspect 16: A non-transitory computer-readable medium storing code for wireless communication at a UE, the code comprising instructions executable by a processor to perform a method of any of aspects 1 through 13.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, a first grant allocating a first set of downlink resources to the UE;
receiving, from the base station and after receiving the first grant, a second grant allocating a second set of downlink resources to the UE;
determining that a slot comprises both resources of the first set of downlink resources and resources of the second set of downlink resources;
generating a feedback codebook for downlink signaling scheduled to be received over the first set of downlink resources, the second set of downlink resources, or both, wherein a size of the feedback codebook is based at least in part on the slot comprising both resources of the first set of downlink resources and resources of the second set of downlink resources; and
transmitting, to the base station, the feedback codebook based at least in part on generating the feedback codebook.

2. The method of claim 1, further comprising:
determining, based at least in part on determining that the slot comprises both the resources of the first set of downlink resources and the resources of the second set of downlink resources, whether the resources of the first set of downlink resources are earlier in the slot than the resources of the second set of downlink resources, wherein the size of the feedback codebook is further based at least in part on whether the resources of the first set of downlink resources are earlier in the slot than the resources of the second set of downlink resources.

3. The method of claim 2, wherein generating the feedback codebook comprises:
generating a single feedback bit for the slot based at least in part on determining that the resources of the first set of downlink resources are not earlier in the slot than the resources of the second set of downlink resources.

4. The method of claim 2, wherein generating the feedback codebook comprises:
generating at least two feedback bits for the slot based at least in part on determining that the resources of the first set of downlink resources are earlier in the slot than the resources of the second set of downlink resources.

5. The method of claim 4, wherein the first set of downlink resources spans a plurality of slots and a last slot of plurality of slots comprises the slot.

6. The method of claim 4, wherein the first set of downlink resources is entirely within the slot and the second set of downlink resources spans a plurality of slots, a first slot of the plurality of slots comprising the slot.

7. The method of claim 1, further comprising:
determining that the first set of downlink resources and the second set of downlink resources are both entirely within the slot, wherein generating the feedback codebook comprises generating at least two feedback bits for the slot based at least in part on determining that the first set of downlink resources and the second set of downlink resources are both entirely within the slot.

8. The method of claim 1, further comprising:
determining the size of the feedback codebook based at least in part on the slot comprising both resources of the first set of downlink resources and resources of the second set of downlink resources.

9. The method of claim 8, wherein determining the size of the feedback codebook comprises:
determining a first quantity of feedback bits to include in the feedback codebook for scheduled downlink signaling on the first set of downlink resources;
determining a second quantity of feedback bits to include in the feedback codebook for scheduled downlink signaling on the second set of downlink resources; and
determining a maximum quantity of feedback bits for the feedback codebook based at least in part on the first quantity of feedback bits and the second quantity of feedback bits, the size of the feedback codebook equal to the maximum quantity of feedback bits.

10. The method of claim 9, wherein determining the maximum quantity of feedback bits comprises:
determining that the first set of downlink resources and the second set of downlink resources do not overlap one another in a time domain; and
determining a third quantity of feedback bits, wherein the third quantity of feedback bits corresponds to a combination of the first quantity of feedback bits and the second quantity of feedback bits, and wherein the third quantity of feedback bits is equal to the maximum quantity of feedback bits.

11. The method of claim 10, further comprising:
receiving, from the base station, a third grant allocating a third set of downlink resources to the UE;
determining a fourth quantity of feedback bits to include in the feedback codebook for scheduled downlink signaling on the third set of downlink resources;
determining that the third set of downlink resources and the first set of downlink resources do not overlap one another in a time domain; and
determining a fifth quantity of feedback bits, wherein the fifth quantity of feedback bits corresponds to a combination of the first quantity of feedback bits and the fourth quantity of feedback bits, and wherein the maximum quantity of feedback bits is equal to the third quantity of feedback bits based at least in part on the fifth quantity of feedback bits being less than the third quantity of feedback bits.

12. The method of claim 1, wherein the first grant and the second grant each comprise multi-physical downlink shared channel scheduling downlink control information or single-physical downlink shared channel scheduling downlink control information.

13. The method of claim 1, wherein the feedback codebook comprises a type-1 hybrid automatic repeat request codebook.

14. An apparatus for wireless communication at a user equipment (UE), comprising:
memory;
a transceiver; and
at least one processor of the UE, the at least one processor coupled with the memory and the transceiver, and the at least one processor configured to cause the apparatus to:
receive, from a base station via the transceiver, a first grant allocating a first set of downlink resources to the UE;
receive, from the base station via the transceiver and after receiving the first grant, a second grant allocating a second set of downlink resources to the UE;
determine that a slot comprises both resources of the first set of downlink resources and resources of the second set of downlink resources;
generate a feedback codebook for downlink signaling scheduled to be received over the first set of downlink resources, the second set of downlink resources, or both, wherein a size of the feedback codebook is based at least in part on the slot comprising both resources of the first set of downlink resources and resources of the second set of downlink resources; and
transmit, to the base station via the transceiver, the feedback codebook based at least in part on generating the feedback codebook.

15. The apparatus of claim 14, the at least one processor further configured to cause the apparatus to:
determine, based at least in part on determining that the slot comprises both the resources of the first set of downlink resources and the resources of the second set of downlink resources, whether the resources of the first set of downlink resources are earlier in the slot than the resources of the second set of downlink resources, wherein the size of the feedback codebook is further based at least in part on whether the resources of the first set of downlink resources are earlier in the slot than the resources of the second set of downlink resources.

16. The apparatus of claim 15, wherein, to generate the feedback codebook, the at least one processor is configured to cause the apparatus to:
generate a single feedback bit for the slot based at least in part on determining that the resources of the first set of downlink resources are not earlier in the slot than the resources of the second set of downlink resources.

17. The apparatus of claim 15, wherein, to generate the feedback codebook, the at least one processor is configured to cause the apparatus to:
generate at least two feedback bits for the slot based at least in part on determining that the resources of the first set of downlink resources are earlier in the slot than the resources of the second set of downlink resources.

18. The apparatus of claim 17, wherein the first set of downlink resources spans a plurality of slots and a last slot of plurality of slots comprises the slot.

19. The apparatus of claim 17, wherein the first set of downlink resources is entirely within the slot and the second set of downlink resources spans a plurality of slots, a first slot of the plurality of slots comprising the slot.

20. The apparatus of claim 14, the at least one processor further configured to cause the apparatus to:
determine that the first set of downlink resources and the second set of downlink resources are both entirely within the slot, wherein, to generate the feedback codebook, the at least one processor is configured to cause the apparatus to generate at least two feedback bits for the slot based at least in part on determining that the first set of downlink resources and the second set of downlink resources are both entirely within the slot.

21. The apparatus of claim 14, the at least one processor further configured to cause the apparatus to:
determine the size of the feedback codebook based at least in part on the slot comprising both resources of the first set of downlink resources and resources of the second set of downlink resources.

22. The apparatus of claim 21, wherein, to determine the size of the feedback codebook, the at least one processor is configured to cause that apparatus to:
determine a first quantity of feedback bits to include in the feedback codebook for scheduled downlink signaling on the first set of downlink resources;
determine a second quantity of feedback bits to include in the feedback codebook for scheduled downlink signaling on the second set of downlink resources; and
determine a maximum quantity of feedback bits for the feedback codebook based at least in part on the first quantity of feedback bits and the second quantity of feedback bits, the size of the feedback codebook equal to the maximum quantity of feedback bits.

23. The apparatus of claim 22, wherein, to determine the maximum quantity of feedback bits, the at least one processor is configured to cause the apparatus to:
determine that the first set of downlink resources and the second set of downlink resources do not overlap one another in a time domain; and
determine a third quantity of feedback bits, wherein the third quantity of feedback bits corresponds to a combination of the first quantity of feedback bits and the second quantity of feedback bits, and wherein the third quantity of feedback bits is equal to the maximum quantity of feedback bits.

24. The apparatus of claim 23, the at least one processor further configured to cause the apparatus to:
receive, from the base station via the transceiver, a third grant allocating a third set of downlink resources to the UE;
determine a fourth quantity of feedback bits to include in the feedback codebook for scheduled downlink signaling on the third set of downlink resources;
determine that the third set of downlink resources and the first set of downlink resources do not overlap one another in a time domain; and
determine a fifth quantity of feedback bits, wherein the fifth quantity of feedback bits corresponds to a combination of the first quantity of feedback bits and the fourth quantity of feedback bits, and wherein the maximum quantity of feedback bits is equal to the third quantity of feedback bits based at least in part on the fifth quantity of feedback bits being less than the third quantity of feedback bits.

25. The apparatus of claim 14, wherein the first grant and the second grant each comprise multi-physical downlink shared channel scheduling downlink control information or single-physical downlink shared channel scheduling downlink control information.

26. The apparatus of claim 14, wherein the feedback codebook comprises a type-1 hybrid automatic repeat request codebook.

27. An apparatus for wireless communication at a user equipment (UE), comprising:
means for receiving, from a base station, a first grant allocating a first set of downlink resources to the UE;
means for receiving, from the base station and after receiving the first grant, a second grant allocating a second set of downlink resources to the UE;
means for determining that a slot comprises both resources of the first set of downlink resources and resources of the second set of downlink resources;
means for generating a feedback codebook for downlink signaling scheduled to be received over the first set of downlink resources, the second set of downlink resources, or both, wherein a size of the feedback codebook is based at least in part on the slot comprising both resources of the first set of downlink resources and resources of the second set of downlink resources; and
means for transmitting, to the base station, the feedback codebook based at least in part on generating the feedback codebook.

28. The apparatus of claim 27, further comprising:
means for determining, based at least in part on determining that the slot comprises both the resources of the first set of downlink resources and the resources of the second set of downlink resources, whether the resources of the first set of downlink resources are earlier in the slot than the resources of the second set of downlink resources, wherein the size of the feedback codebook is further based at least in part on whether the resources of the first set of downlink resources are earlier in the slot than the resources of the second set of downlink resources.

29. A non-transitory computer-readable medium storing code for wireless communication at a user equipment (UE), the code comprising instructions executable by a processor to:
receive, from a base station, a first grant allocating a first set of downlink resources to the UE;
receive, from the base station and after receiving the first grant, a second grant allocating a second set of downlink resources to the UE;
determine that a slot comprises both resources of the first set of downlink resources and resources of the second set of downlink resources;
generate a feedback codebook for downlink signaling scheduled to be received over the first set of downlink resources, the second set of downlink resources, or both, wherein a size of the feedback codebook is based at least in part on the slot comprising both resources of the first set of downlink resources and resources of the second set of downlink resources; and
transmit, to the base station, the feedback codebook based at least in part on generating the feedback codebook.

30. The non-transitory computer-readable medium of claim 29, wherein the instructions are further executable by the processor to:
determine, based at least in part on determining that the slot comprises both the resources of the first set of downlink resources and the resources of the second set of downlink resources, whether the resources of the first set of downlink resources are earlier in the slot than the resources of the second set of downlink resources, wherein the size of the feedback codebook is further based at least in part on whether the resources of the first set of downlink resources are earlier in the slot than the resources of the second set of downlink resources.
